(19) United States
(12) Patent Application Publication
(10) Pub. No.: US 2014/0187308 A1
(43) Pub. Date: Jul. 3, 2014

(54) GAME MACHINE

(71) Applicant: Kyoraku Industrial Co., Ltd., Nagoya-shi (JP)

(72) Inventors: Ryo Morimoto, Nagoya (JP); Yukinaga Yasuda, Nagoya (JP); Yasutake Suzuki, Nagoya (JP); Yuji Isogimi, Nagoya (JP); Masayuki Taniguchi, Nagoya (JP); Yasunori Higuchi, Nagoya (JP); Tomoshige Kawai, Nagoya (JP); Tatsuya Nakamura, Nagoya (JP); Mitsuhiro Kanemoto, Nagoya (JP); Satoshi Manabe, Nagoya (JP)

(73) Assignee: Kyoraku Industrial Co., Ltd., Nagoya-shi (JP)

(21) Appl. No.: 14/138,920

(22) Filed: Dec. 23, 2013

(30) Foreign Application Priority Data
Dec. 28, 2012 (JP) 2012-287680
Dec. 28, 2012 (JP) 2012-287681

(51) Int. Cl. G07F 17/34

(52) U.S. Cl. CPC G07F 17/34
USPC 463/20

(57) ABSTRACT

A game machine includes a performance device configured to be able to provide various performances corresponding to a progress of a game. The performance device includes a first object configured to be able to move; a mover configured to move the first object; and a second object configured to be able to hide the first object from a player. The first object can move between a first position where the first object is covered by the second object that is located in a predetermined position and a second position where the first object is not covered by the second object. When a predetermined requirement is met, the mover moves the first object from the first position to the second position.

### CROSS-REFERENCES TO RELATED APPLICATIONS

This application claims the benefit of Japanese Patent Applications No. 2012-287680 and No. 2012-287681, filed Dec. 28, 2012, which are incorporated herein by reference.

### BACKGROUND

1. Technical Field

The present invention relates to a game machine.

2. Related Art

Conventionally, there has been known a game machine including a plurality of reels each of which includes symbols that are printed on the circumferential surface thereof; and a display window to show part of the symbols on the reels. This game machine is called “Pachisuro”, and, when the player inserts a game value such as medals into the game machine and operates the start lever, all the reels are spun, and then when the player operates stop buttons, respective reels are stopped, so that the symbols are displayed within the display window. With this game machine, when a predetermined combination of symbols is arranged on a predetermined line (hereinafter “pay line” so as to be shown in the display window, prizes (e.g. medals) are provided to the player.

In addition, with this game machine, the following steps are performed: detecting the player operating the start lever; sampling a predetermined random number value based on the detection of the operation of the start lever; determining whether or not to allow a combination of symbols corresponding to the conditions to be produced based on the sampled random number value and an internal lottery table in which a lottery value is defined for each condition (hereinafter this step is referred to as “internal lottery”); performing reel stop control, based on a requirement is met to arrange the combination of symbols corresponding to a predetermined title on the pay line (hereinafter referred to as “internal lottery winning condition”; and displaying the combination of symbols corresponding to the internal lottery winning condition.

In this case, when any title is not acquired in the internal lottery, that is, the lottery results in a loss, the combination of symbols corresponding to the internal lottery winning condition is not displayed even if the stop buttons are operated. In addition, the title determined under the internal lottery winning condition may include: a title not to arrange the combination of symbols corresponding to the title on the pay line unless stop buttons are operated at appropriate times; and a title to arrange the combination of symbols corresponding to the title on the pay line even if the stop button are operated at any time. Moreover, the title determined under the internal lottery winning condition may further include a title not to display the combination of symbols corresponding to the title unless the operation order of the stop buttons is correct.

That is, in a case in which the title is determined under the internal lottery winning condition, which does not to arrange the combination of symbols corresponding to the title on the pay line, unless the stop buttons are operated at appropriate times or in an appropriate order, it is necessary to operate the stop buttons at appropriate times or in an appropriate order. Therefore, the player has to acquire a certain level of technique or skills to operate the stop buttons.

In addition, with this game machine, when the predetermined combination of symbols is arranged on the pay line, the game state moves to an advantageous state to the player. Here, the advantageous state to the player includes: a bonus game condition, such as a regular bonus (RB), a big bonus (BB), a challenge (CB), and a middle bonus (MB), which improves the probability to determine the title to pay out medals under the internal lottery winning condition; a replay time (RT) that improves the probability to determine a replay as a title to allow the game to be started by operating the start lever despite that any game value is not put, under the internal lottery winning condition; and an assist replay time (ART) that informs an appropriate order to operate the operation buttons when a specific title is determined under the internal lottery winning condition while providing the RT. Here, when the specific title is determined, the combination of symbols corresponding to the title is not arranged unless the stop buttons are operated in an appropriate order, or when a plurality of titles are determined under the internal lottery winning conditions, a combination of symbols that is less advantageous to the player is arranged. Therefore, the player playing the game wishes to move the game to an advantageous state.

Meanwhile, conventionally, there has been known a game machine having movable objects called “gimmick” or “object” that mimic characters. This game machine improves the amusement of the player during the game by operating the movable objects corresponding to the probabilities of winning or losing of the game (see Patent Literature 1).

With this game machine, it is possible to improve the amusement of the player by providing various operation modes of the movable objects, as well as the player can be enjoyed because it is possible to know whether the player is winning or losing during the game.

### Patent Literature 1: Japanese Patent Application Laid-Open No. 2008-132358

However, with the above-described conventional game machines, there is a problem that the movable objects have already been shown before a game is started, and therefore the player could predict the motions of the movable objects, and so that the player may lose the amazement and wonder.

### SUMMARY

In view of the above-described problem, it is therefore an object of the present invention to provide a game machine that can improve the amusement of the player during a game.

To solve the problem, the game machine according to the present invention includes a performance device configured to be able to provide various performances corresponding to a progress of a game, the performance device including: a first object configured to be able to move; a mover configured to move the first object; a second object configured to be able to hide the first object from a player, wherein: the first object can move between a first position where the first object is covered by the second object that is located in a predetermined position and a second position where the first object is not covered by the second object; and when a predetermined requirement is met, the mover moves the first object from the first position to the second position.

With this arrangement, when the first object covered by the second object suddenly appears, the player is astonished and moved because the player did not expect that, so that it is possible to improve the amusement of the player.

Moreover, the second object may be a display device that displays information on a game. In this case, the player pays attention to the information on the game displayed on the display device, and therefore might not notice the first object, so that it is possible to improve the amusement of the player as compared to when the first object is hidden by an object that displays no information.

According to the present invention, it is possible to provide a game machine that can improve the amusement of the player during a game.

### BRIEF DESCRIPTION OF THE DRAWINGS

FIG. 1 is an exemplary front view showing a game machine;

FIG. 2 is an exemplary drawing showing the inner structure of a cabinet;

FIG. 3 is an exemplary drawing showing the rear surface of a front door;

FIG. 4A is an exemplary block diagram showing the entire game machine;

FIG. 4B is the remaining part of the block diagram showing the entire game machine;

FIG. 5 is an exemplary drawing showing a symbol arrangement table;

FIG. 6 is an exemplary drawing showing a performance determination table;

FIG. 7 is a drawing showing program start processing in a main control board;

FIG. 8 is a drawing showing main loop processing in the main control board;

FIG. 9 is a drawing showing interrupt processing in the main control board;

FIG. 10 is a drawing showing main processing in a sub-control board;

FIG. 11 is a drawing showing a main control board communication task in the sub-control board;

FIG. 12 is a drawing showing an image control task in the sub-control board;

FIG. 13 is a drawing showing command analysis processing in the sub-control board;

FIG. 14 shows a perspective view showing a liquid crystal (LC) display device, an LC drive unit and a bar unit;

FIG. 15A is a perspective view showing the LC display device and the LC drive unit, separated from the bar unit;

FIG. 15B is a perspective view showing the bar unit, separated from the LC display device and the LC drive unit;

FIG. 16A is a perspective view showing the primary parts of the LC display device and the LC drive unit from one side;

FIG. 16B is a perspective view showing the primary parts of the LC display device and the LC drive unit from the front side;

FIG. 17 is a perspective view showing the LC display device after being moved upward and the LC drive unit.

FIG. 18 is a perspective view showing a bar forward and backward drive unit;

FIG. 19 is a perspective view showing the title bar after being moved forward and the bar unit;

FIG. 20 is a perspective view showing a bar upward and downward drive unit;

FIG. 21A is a drawing showing part of the exploded bar upward and downward drive unit;

FIG. 21B is a drawing showing part of the exploded bar upward and downward drive unit;

FIG. 22 is a perspective view showing the title bar after being moved upward and the bar unit;

FIG. 23 is a perspective view showing the LC display device moved upward and the title bar moved forward;

FIG. 24 is a perspective view showing the LC display device moved upward, and the title bar moved forward and upward;

FIG. 25 is a front view showing the game machine with the LC display device moved upward and the title bar moved forward;

FIG. 26 is a front view showing the game machine with the LC display device moved upward and the title bar moved forward and upward;

FIG. 27 is a front view showing an exemplary pachinko game machine;

FIG. 28 is a front view showing the pachinko game machine with the LC display device and the title bar being operated; and

FIG. 29 is a perspective view showing a video game machine according to another embodiment.

### DESCRIPTION OF EXEMPLARY EMBODIMENTS

Now, an embodiment of the present invention will be described in detail with reference to the drawings.

<The Configuration of a Game Machine>

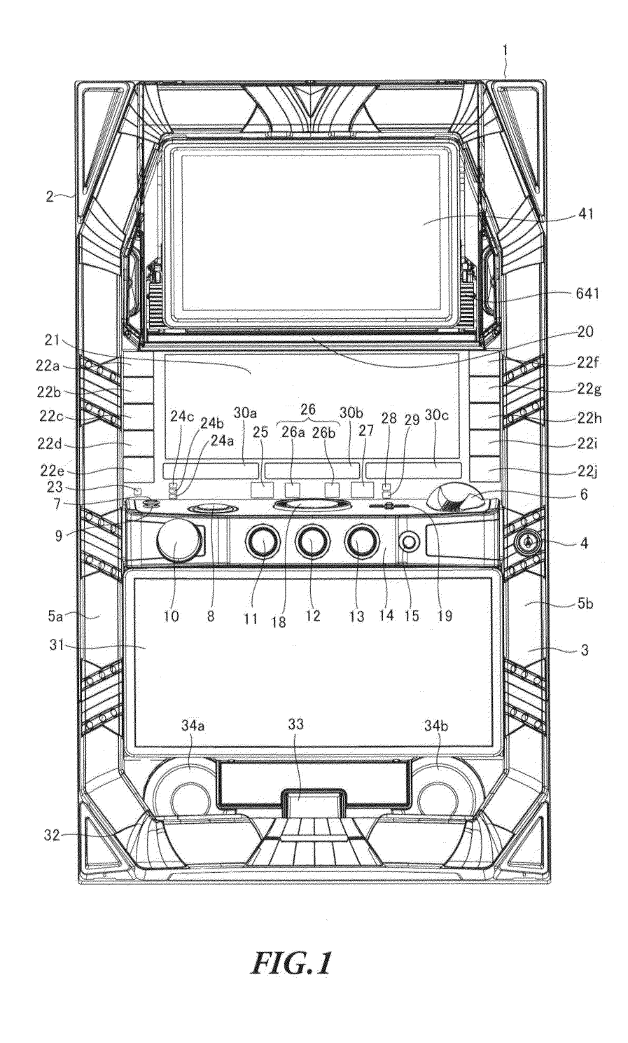

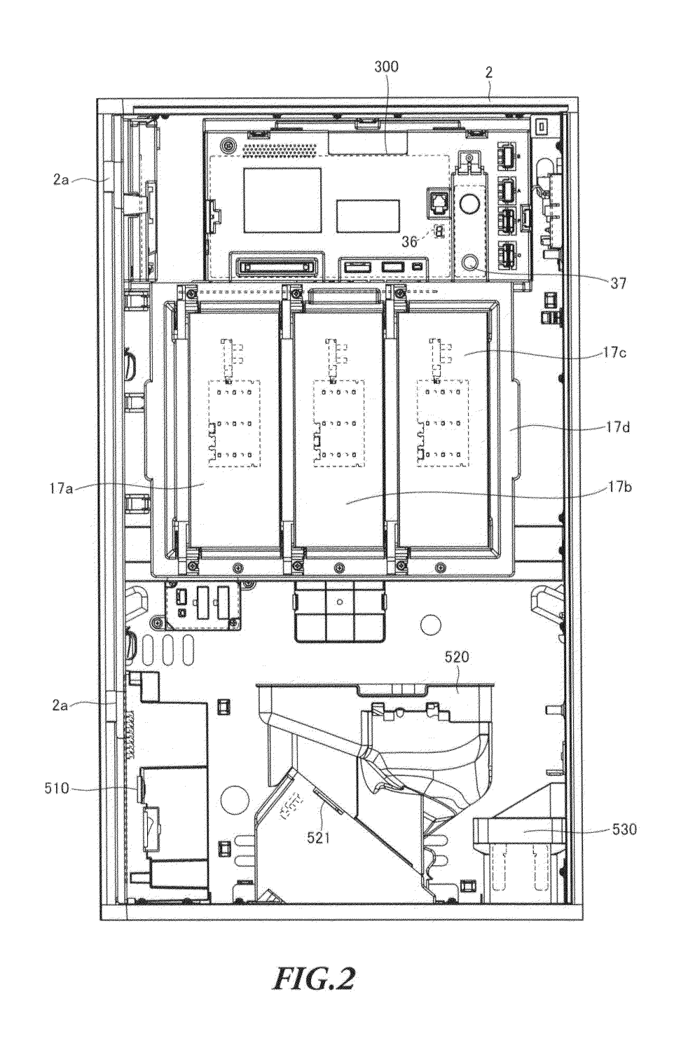

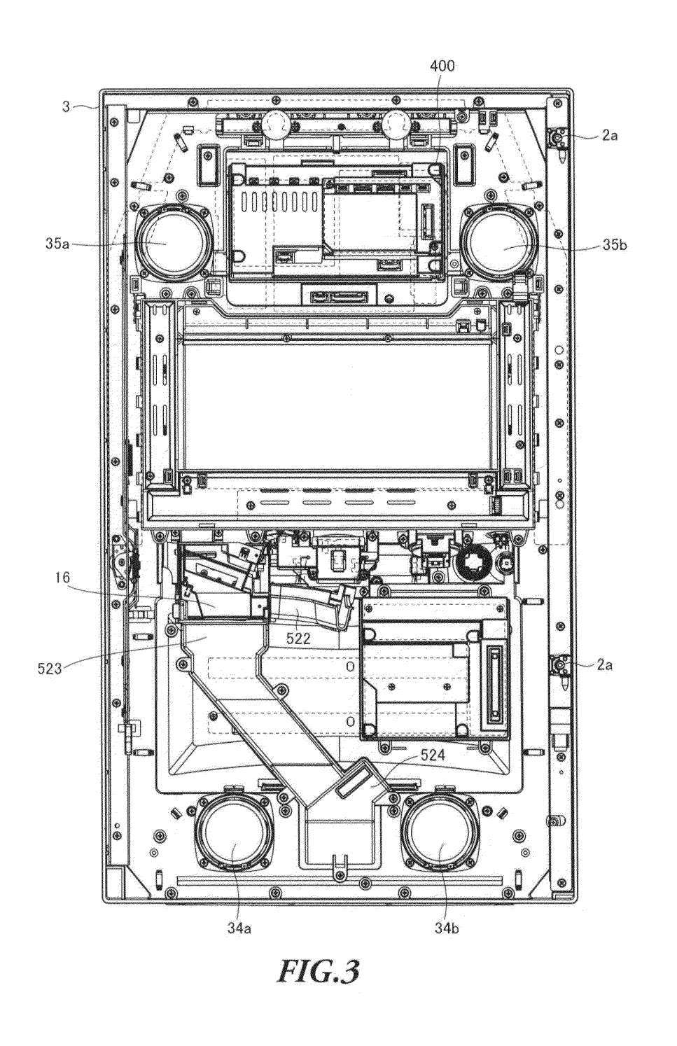

First, the configuration of a game machine 1 according to the present invention will be described in detail with reference to FIG. 1 to FIG. 3. FIG. 1 is an exemplary front view showing the game machine. FIG. 2 is an exemplary drawing showing the inner structure of a cabinet 2. FIG. 3 is an exemplary drawing showing the rear surface of a front door.

<Game Machine 1>

The game machine 1 according to the present embodiment includes the cabinet 2, the front door 3 and so forth. Here, the game machine 1 is equivalent to “game machine” recited in the appended claims. Hereinafter, “front” “back” “right” and “left” are defined as being viewed from the front side of the game machine 1.

<Cabinet 2, Hinge Mechanism 2a, and Front Door 3>

A cabinet 2 is formed of an approximately rectangular box, and has an opening in its front side. A hinge mechanism 2a provided on the front left side of the cabinet 2 pivotally supports a front door 3 to open and close the front door 3.

<Key Hole 4>

The keyhole 4 is provided in the middle of the right edge of the front door 3 to lock and unlock the front door 3. Here, when a staff member of a game parlor does maintenance work or changes the setting value and so forth, the staff member unlocks and locks a lock device (not shown) provided in the front door 3. First, a dedicated key (not shown) is inserted into the key hole 4 in the front door 3 to unlock and open the front door 3, and then the maintenance work is done, and the setting value are changed. After that, when the maintenance work and the change in the setting value are finished, the dedicated key is inserted into the key hole 4 to lock the front door 3.

<Side Lamps 5a and 5b>

Side lamps 5a and 5b are provided on the right and left edges of the front door 3, and each of which includes a plurality of super bright LEDs. In addition, these side lamps 5a and 5b are designed to have shapes, colors, patterns, pictures and so forth which appeal to the player's eyes. During an ART (assist replay time) state, lighting or blinking control is performed by a sub-control board 400 during a predetermined performance or demonstration at a predetermined time, so that a performance is presented. Hereinafter, the side lamps 5a and 5b may be collectively referred to as “side lamps 5”.

<Medal Insertion Slot 6>

A medal insertion slot 6 is provided in the right side of a numerical keyboard 19 and used to insert medals by the player.

<One-Bet Button 7>

A one-bet button 7 is provided below a start lamp 23 to use one of credited medals for a game.

<Max-Bet Button 8>

A max-bet button 8 is provided on the right side of the one-bet button 7 to use the maximum number of credited medals available for one game. Here, with the present embodiment, the maximum number of medals for one game is three. Hereinafter, the one-bet button 7 and the max-bet button 8 may be collectively referred to as “bet buttons 7 and 8.”

<Adjustment Button 9>

An adjustment button 9 is provided below the start lamp 23 to adjust the credited ones of the medals acquired by the player. Here, with the present embodiment, the maximum number of creditable medals is fifty.

<Start Lever 10>

A start lever 10 is provided on the right side of the adjustment button 9 to detect a game start operation by the player. Here, based on the detection of the start operation, a random number value may be sampled by a main control board 300, and spins of a left reel 17a, a center reel 17b and a right reel 17c may be started. In addition, a knob of the start lever 10 is made of translucent resin, and includes a start lever performance lamp 42. Then, a sub-control board 400 controls the lighting and blinking of the start lever performance lamp 42, based on that a predetermined requirement is met. By this means, it is possible to present a performance which appeals to the player's eyes.

<Left Stop Button 11, Middle Stop Button 12, Right Stop Button 13, and Stop Button Unit 14>

A left stop button 11, a middle stop button 12 and a right stop button 13 are provided on the right side of the start lever 10 and unitized by the stop button unit 14. Also, the left stop button 11, the middle stop button 12 and the right stop button 13 are provided to detect a stop operation by the player to stop a left reel 17a, a middle reel 17b and a right reel 17c from spinning. Hereinafter, the left stop button 11, the middle stop button 12 and the right stop button 13 may be collectively referred to as “stop buttons 11, 12 and 13.” In addition, the stop buttons 11, 12 and 13 include stop button performance lamps (not shown), respectively. Then, the sub-control board 400 controls the lighting and blinking of the stop button performance lamp, based on that a predetermined requirement is met. By this means, it is possible to present a performance which appeals to the player's eyes.

<Return Button 15>

A return button 15 is provided on the right side of the stop button unit 14. When a medal inserted into the medal insertion slot 6 is jammed in a selector 16, the return button 15 is used to return the jammed medal.

<Selector 16>

The selector 16 is provided in the medal insertion slot 6 to determine whether or not the material and shape of the medal inserted into the medal insertion slot 6 is appropriate. A medal sensor 16s is provided in the selector 16 to detect an appropriate medal passing through. Then, when the medal sensor 16s determines that the medal inserted into the medal insertion slot 6 is appropriate, a hopper guide member 522 guides this appropriate medal to a hopper 520. On the other hand, when the medal sensor 16s determines that the medal inserted into the medal insertion slot 6 is not appropriate, a guide member 523 ejects the medal from a medal payout slot 33.

<Left Reel 17a, Middle Reel 17b, Right Reel 17c, and Reel Unit 17d>

The left reel 17a, the middle reel 17b and the right reel 17c are provided in the cabinet 2 and each has a cylindrical structure. In addition, a translucent sheet is attached to the peripheral surface of the cylindrical structure of each of the left reel 17a, the middle reel 17b and the right reel 17c, and has a plurality of kinds of symbols which are arranged in a line. Then, stepping motors 101, 102 and 103 are excited to spin the left reel 17a, the middle reel 17b and the right reel 17c, so that a plurality kinds of symbols on each reel are sequentially displayed as the reel is spinning. With the present embodiment, the left reel 17a, the middle reel 17b and the right reel 17c are unitized as a reel unit 17d and easily attached to and detached from the game machine 1. Hereinafter, the left reel 17a, the middle reel 17b and the right reel 17c may be collectively referred to as “reels 17”.

<Performance Button 18>

A performance button 18 is provided on the right side of the max-bet button 8 and used to control a liquid crystal (LC) display device 41 by the sub-control board 400 when the player's operation is detected during a predetermined performance. Here, the performance button 18 may not be provided, but the one-bet button 7 and the max-bet button 8 may serve as the performance button 18. In this case, a command is sent to the sub-control board 400 based on that the one-bet button 7 or the max-bet button 8 is operated, and the sub-control board 400 controls the LC display device 41, based on that the sub-control board 400 has received the command. By this means, the performance button 18 does not need to be provided separately, so that it is possible to reduce the number of parts. In addition, a performance button lamp (not shown) is built in the performance button 18. Then, the sub-control board 400 controls the lighting and blinking of the performance button lamp, based on that a predetermined requirement is met. By this means it is possible to present a performance which appeals to the player's eyes.

<Numerical Keypad 19>

A numerical keypad 19 is provided on the right side of the performance button 18 and can be pushed in at least two directions (usually in four directions) to accept the player's operation.

<Panel 20 and Display Window 21>

A panel 20 is provided to display performance lamps 22a to 22j, a start lamp 23, bet lamps 24a to 24c, an accumulated medal number display 25, a game state display lamp 26, a payout number display 27, an insertion possible display lamp 28, a replay display lamp 29, and stop operation order display lamps 30a to 30c. In addition, a display window 21 is provided in the panel 20 to allow the left reel 17a, the middle reel 17b and the right reel 17c to be seen and recognized.

<Performance Lamps 22a to 22j>

Performance lamps 22a to 22j are provided on the rear surface of the translucent portions of the panel 20 on its right and left edges and are lit under predetermined requirements to inform the current state (for example, an ART state). The performance lamps 22a to 22e are provided on the left side of the display window 21, and the performance lamps 22f to 22j are provided on the right side of the display window 21. Hereinafter, the performance lamps 22a to 22j may be collectively referred to as “performance lamps 22.”

<Start Lamp 23>

The start lamp 23 is provided above the one-bet button 7 to inform whether or not it is possible to accept the start operation of the start lever 10. To be more specific, in a case in which three medals are inserted into the medal insertion slot 6, or in a case in which the max-bet button 8 is operated while the number of accumulated medals is three, the start lamp 23 is lit to inform that it is possible to accept the start operation by the start lever 10.

<Bet Lamps 24a to 24c>

The bet lamps 24a to 24c are provided on the right side of the start lamp 23 to inform the number of inserted medals to be used for a game. To be more specific, when the number of inserted medals is one, the bet lamp 24a is lit; when the number of inserted medals is two, the bet lamp 24b is lit; and when the number of inserted medals is three, the bet lamp 24c is lit. Hereinafter, the bet lamps 24a to 24c may be collectively referred to as “bet lamps 24”.

<Accumulated Medal Number Display 25>

The accumulated medal number display 25 is provided on the right side of the bet lamp 24. Also the accumulated medal number display 25 is provided to display the number of medals which belong to the player and are accumulated in the game machine 1.

<Game State Display Lamps 26a and 26b>

The game state display lamps 26a and 26b are provided on the right side of the accumulated medal number display 25. The main control board 300 controls the lighting of the game state display lamps 26a and 26b, so that the current game state is informed. Hereinafter, the game state display lamps 26a and 26b may be collectively referred to as “game state display lamps 26”.

The payout number display 27 is provided on the right side of the game state display lamp 26b. The payout number display 27 is provided to display the number of medals to be paid out according to the number of medals inserted into the medal insertion slot 6, or a combination of the symbols arranged on a pay line which is enabled by operating the one-bet button 7 or the max-bet button 8. Here, with the present embodiment, three symbols are displayed for each of the left reel 17a, the middle reel 17b and the right reel 17c in the display window 21. Here, the pay line means a falling diagonal line from left to right obtained by connecting the symbol of the upper stage of the left reel 17a, the symbol of the middle stage of the middle reel 17b and the symbol of the lower stage of the right reel 17c.

Hereinafter, the straight line obtained by connecting the symbol of the upper stage of the left reel 17a, the symbol of the upper stage of the middle reel 17b and the symbol of the upper stage of the right reel 17c may be referred to as “upper stage” or “upper stage line.” In addition, the straight line obtained by connecting the symbol of the middle stage of the left reel 17a, the symbol of the middle stage of the middle reel 17b and the symbol of the middle stage of the right reel 17c may be referred to as “middle stage” or “middle stage line.” Moreover, the straight line obtained by connecting the symbol of the lower stage of the left reel 17a, the symbol of the lower stage of the middle reel 17b and the symbol of the lower stage of the right reel 17c may be referred to as “lower stage” or “lower stage line.” Furthermore, the straight line obtained by connecting the symbol of the lower stage of the left reel 17a, the symbol of the middle stage of the middle reel 17b and the symbol of the upper stage of the right reel 17c may be referred to as “diagonally right up” or “a rising diagonal line from left to right.”

<Insertion Possible Display Lamp 28>

The insertion possible display lamp 28 is provided on the right side of the payout number display 27. The insertion possible display lamp 28 is lit to inform that it is possible to accumulate the medal which has just been inserted into the medal insertion slot 6. Meanwhile, the insertion possible display lamp 28 is turned off to inform that it is not possible to accumulate the medal which has just been inserted into the medal insertion slot 6.

Here, with the present embodiment, the maximum number of medals that can be credited is “50”. Therefore, when the number of the accumulated medals is smaller than “50”, the main control board 30 performs the control to light the insertion possible display lamp 28, and, meanwhile, when the number of the accumulated medals is “50”, the main control board 30 performs the control to turn off the insertion possible display lamp 28. In addition, when a combination of symbols that is associated with “replay” (described later) is displayed on the pay line, the main control board 30 performs the control to turn off the insertion possible display lamp 28.

<Replay Display Lamp 29>

The replay display lamp 29 is provided below the insertion possible display lamp 28. The replay display lamp 29 is lit when the combination of symbols which is associated with a replay is displayed on the pay line. By this means, it is possible to inform the player that the combination of symbols which is associate with the replay on the pay line. This also informs the player that it is possible to play a next game without consuming a medal.

<Stop Operation Order Display Lamps 30a to 30c>

The stop operation order display lamps 30a to 30c are provided below the display window 21. To be more specific, the stop operation order display lamp 30a is provided below the left reel 17a; the stop operation order display lamp 30b is provided below the middle reel 17b; and the stop operation order display lamp 30a is provided below the right reel 17c. In addition, the stop operation order display lamps 30a to 30c are provided to inform the player of the optimum order to stop the left stop button 11, the middle stop button 12 and the right stop button 13, based on a win area determined by the main control board 300. To be more specific, at the optimum time to stop the left stop button 11, the stop operation order display lamp 30a is lit or blinked; at the optimum time to stop the middle stop button 12, the stop operation order display lamp 30b is lit or blinked; and at the optimum time to stop the right stop button 13, the stop operation order display lamp 30c is lit or blinked. By this means, the player is informed of the order.

<Waist Part Panel 31>

A waist part panel 31 is provided below the stop button unit 14 to allow the player to recognize the model name, the motif and so forth of the game machine 1. To be more specific, the illustrations of the characters are drawn on the waist part panel 31. In addition, a light (not shown) is provided on the rear surface of the waist part panel 31, and the sub-control board 400 controls the lighting of the light, so that the player can easily recognize the model name, the motif and so forth of the game machine 1.

<Tray Unit 32>

A tray unit 32 is provided below the waist part panel 31 to receive and accumulate the medals discharged from the medal payout slot 33.

<Medal payout slot 33>

In a case in which medals are paid out based on the combination of symbols displayed on the pay line, when the hopper 520 is driven, the medal payout slot 33 is used to discharge the medals which the hopper has paid out. In addition, when the medal sensor 16s determines that the medal inserted into the medal insertion slot 6 is not appropriate, or when a medal is inserted into the medal insertion slot 6 despite that the medal insertion slot 6 is not allowed to accept any medal, the medal payout slot 33 is used to discharge the medal inserted into the medal insertion slot 6 to the tray unit 32.

Here, the case in which the medal insertion slot 6 is not allowed to accept any medal is, for example, a case in which the left reel 17a, the middle reel 17b and the right reel 17c are spinning, or a case in which the combination of symbols which is associated with a replay is displayed on the pay line.

<Lower Speakers 34a and 34b>

Lower speakers 34a and 34b are provided on the right and left sides of the medal payout slot 33 to output BGM, voice, and special effects during a performance. Hereinafter, the lower speakers 34a and 34b may be collectively referred to as “lower speakers 34”.

<Upper Speakers 35a and 35b>

Upper speakers 35a and 35b are provided on the right and left sides of the LC display device 41 to output BGM, voice and special effects during a performance, like the lower speakers 34a and 34b. Hereinafter, the upper speakers 35a and 35b may be collectively referred to as “upper speakers 35”, and the lower speakers 34a and 34b, and the upper speakers 35a and 35b may be referred to as “speakers 34 and 35”.

<Setting Display Part 36>

A setting display part 36 is provided to display the current setting value. To be more specific, when a setting change key (not shown) is inserted into a key hole (not shown) and turned for a predetermined angle, the setting value which is currently set is displayed on the setting display part 36 under the control of the main control board 300.

<Setting Change Button 37>

A setting change button 37 is provided to change setting values. Here, when a setting value is changed, first, a setting change key (not shown) is inserted into the key hole and rotated for a predetermined angle. Next, the setting change button 37 is operated so as to be able to change the setting value on the setting display part 36. Then, when a value that is intended to be set as the setting value is displayed on the setting display part 36 by operating the setting change button 37, the start lever 10 is operated to return the angle of the rotated setting change key to the angle that allows the setting change key to be taken out, so that it is possible to change the setting value.

Here, with the present embodiment, the setting value can be changed in six steps from “1” to “6”. When the setting change button 37 is operated while “1” is displayed on the setting display part 36, “2” is displayed on the setting display part 36. Subsequently, the setting value is incremented by one every time the setting change button 37 is operated. Here, when the setting change button 37 is operated while “6” is displayed on the setting display part 36, “1” is displayed on the setting display part 36.

<LC Display Device 41>

The LC display device 41 is provided on the reels 17 to present performances with the displays of moving images and still images. In addition, the LC display device 41 is used to provide the information on the result of an internal lottery process (described later) and also provide information required to stop and display the combination of symbols for a win on the pay line. Here, the LC display device 41 is equivalent to “second object” recited in the appended claims.

In addition, with the present embodiment, a drive mechanism is provided that allows the LC display device 41 to move upward and downward. Here, another configuration is possible where a different object device (title bar 641) from the LC display device 41 is provided and moves upward and downward with the LC display device 41 or independently. For example, this object device is usually located in the back surface side of the LC display device 41, and the sub-control board 400 controls the object device such that the object device protrudes in front of the LC display device 41 based on that a predetermined requirement is met and covers the display area of the LC display device 41. By this means, it is possible to provide various modes of the movement of the LC display device 41 with the object device. In addition, the LC display device 41 and the object device are coated with transparent resin, and therefore are protected from outside intrusion. The resin may be, for example, acrylate resin, reinforced plastic, polycarbonate and so forth.

<Main Control Board 300>

The main control board 300 is provided above the reels 17 in the cabinet 2 to control the game machine 1. The main control board 300 will be described in detail later.

<Sub-Control Board 400>

The sub-control board 400 is provided in the upper part of the rear surface of the front door 3 to control the LC display device 41, the speakers 34 and 35. The sub-control board 400 will be described in detail later.

<Power-Supply Unit 510>

A power-supply unit 510 is provided in the cabinet 2 to supply a voltage to the game machine 1.

<Hopper 520>

The hopper 520 is provided in the cabinet 2 to pay out medals to the player. In addition, the drive of the hopper 520 is controlled based on a predetermined signal from the main control board 300. The power-supply board 500 determines whether or not a predetermined number of medals has been discharged based on the medal sensor (not shown) provided on the hopper 520, and, when determining that the predetermined number of medals has been discharged, transmits a signal indicating that the payout has been done to the main control board 300. By this means, the main control board 300 can recognize that the payout has been done.

<Discharge Slit 521>

A discharge slit 521 is provided in the hopper 520 to discharge a medal from the hopper 520.

<Hopper Guide Member 522>

The hopper guide member 522 is provided to guide a medal having just been inserted into the medal insertion slot 6 to the hopper 520 provided in the cabinet 2 when the medal sensor 16s determines that the medal is appropriate.

<Guide Member 523>

When the medal insertion slot 6 receives an object different from a medal, or when the medal sensor 16s determines that a medal having just been inserted into the medal insertion slot 6 is not appropriate, the guide member 523 guides the object or the inappropriate medal to the medal payout slot 33.

<Payout Guide Member 524>

A payout guide member 524 is provided to guide the medal discharged from the discharge slit 521 in the hopper 520 to the medal payout slot 33 in the tray unit 32.

<Auxiliary Accumulating Part 530>

An auxiliary accumulating part 530 is provided to accommodate overflow medals from the hopper 520.

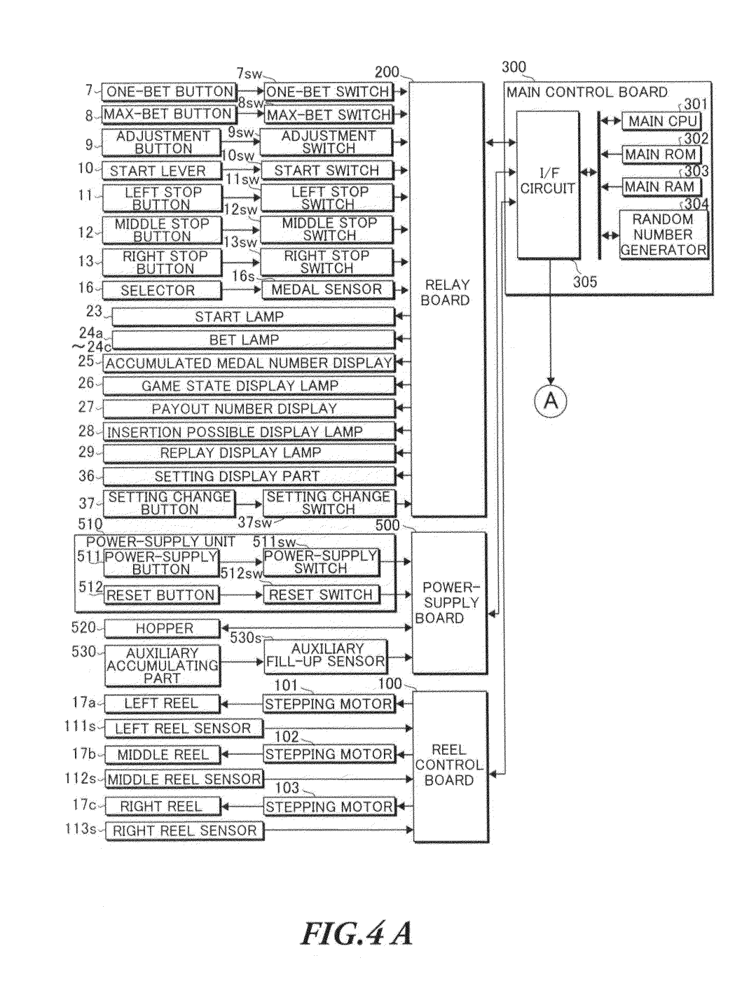

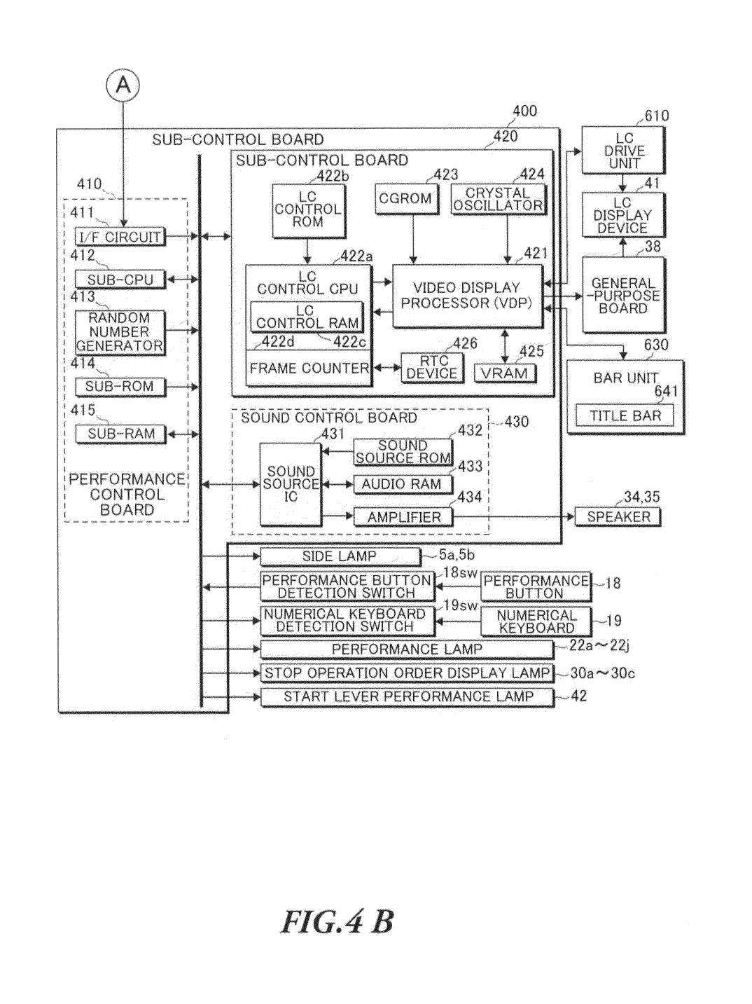

Next, the configuration of the game machine 1 according to the present invention will be described in detail with reference to FIGS. 4A and 4B.

In the game machine 1, a reel control board 100, a rely board 200, the sub-control board 400 and the power source board 500 are connected to the main control board 300 that controls main operations of the game machine 1.

<Main Control Board 300>

A main CPU 301, a main ROM 302, a main RAM 303, a random number generator 304 and an I/F (interface) circuit 305 are connected to the main control board 300.

<Main CPU 301>

The main CPU 301 reads a program stored in the main ROM 302 and performs predetermined arithmetic processing along with the progression of the game to transmit a predetermined signal to the reel control board 100, the relay board 200, the sub-control board 400 and the power-supply board 500.

<Main ROM 302>

The main ROM 302 stores the control program performed by the main CPU 301, data tables such as a win area determination table, and data to transmit a command to the sub-control board 400.

<Main RAM 303>

The main RAM 303 includes a storage area to store various data determined by executing the program by the main CPU 301. In addition, the main RAM 303 serves to temporarily store the result of the calculation by the main CPU 301.

<Random Number Generator 304>

The random number generator 304 is provided to generate random numbers to determine a win area and so forth. Here, with the present embodiment, the random number generator 304 generates random number values within the range from “0” to “65535”.

<IF circuit 305>

The IF circuit 305 is provided to transmit and receive commands between the main control board 300 and the other boards, the reel control board 100, the relay board 200, the sub-control board 400 and the power-supply unit board 500.

<Relay board 200>

The following components are connected to the relay board 200: a one-bet switch 7sw; a max-bet switch 8sw; an adjustment switch 9sw; the start switch 10sw; a left stop switch 11sw; a middle stop switch 12sw; a right stop switch 13sw; the medal sensor 16s; the start lamp 23; the bet lamp 24; the accumulated medal number display 25; the game state display lamp 26; the payout number display 27; the insertion possible display lamp 28; the replay display lamp 29; the setting display 36; and a setting change switch 37sw.

<One-Bet Switch 7sw>

The one-bet switch 7sw is provided to detect the one-bet button 7 being operated by the player. When the one-bet switch 7sw detects the one-bet button 7 being operated by the player, the relay board 200 transmits a predetermined signal to the I/F circuit 305 in the main control board 300. Then, the main CPU 301 controls such that the player uses one of the accumulated medals, based on that the I/F circuit 305 has received the predetermined signal from the relay board 200.

<Max-Bet Switch 8sw>

The max-bet switch 8sw is provided to detect the max-bet button 8 being operated by the player. When the max-bet switch 8sw detects the max-bet button 8 being operated by the player, the relay board 200 transmits a predetermined signal to the I/F circuit 305 in the main control board 300. Then, the main CPU 301 controls such that the player uses three of the accumulated medals, based on that the I/F circuit 305 has received the predetermined signal from the relay board 200. Hereinafter, the one-bet switch 7sw and the max-bet switch 8sw may be collectively referred to as “bet switches 7sw and 8sw.

<Adjustment Switch 9sw>

The adjustment switch 9sw is provided to detect the adjustment button 9 being operated by the player. When the adjustment switch 9sw detects the adjustment button 9 being operated by the player, the relay board 200 transmits a predetermined signal to the I/F circuit 305 in the main control board 300. Then, the main CPU 301 outputs a signal to the hopper 520 in the power-supply board 500 to return the accumulated medals, based on that the I/F circuit 305 has received the predetermined signal from the relay board 200, so that the hopper 520 returns the accumulated medals.

<Start Switch 10sw>

The start switch 10sw is provided to detect the start lever 10 being operated by the player. When the start switch 10sw detects the start lever 10 being detected by the player, the relay board 200 transmits a predetermined signal to the I/F circuit 305 in the main control board 300. Then, the main CPU 301 controls such that spin of the reels 17 is started, based on that the I/F circuit 305 has received the predetermined signal from the relay circuit 200.

<Left Stop Switch 11sw>

The left stop switch 11sw is provided to detect the left stop button 11 being operated by the player. When the left stop switch 11sw detects the left stop button 11 being operated by the player, the relay board 200 transmits a predetermined signal to the I/F board 305 in the main control board 300. Then, the main CPU 301 controls to stop the left reel 17a from spinning, based on that the I/F circuit 305 has received the predetermined signal from the relay board 200.

<Middle Stop Switch 12sw>

The middle stop switch 12sw is provided to detect the middle stop button 12 being operated by the player. When the middle stop switch 12sw detects the middle stop button 12 being operated by the player, the relay circuit 200 transmits a predetermined signal to the I/F circuit 305 in the main control board 300. Then, the main CPU 301 controls to stop the middle reel 17b from spinning, based on that the I/F circuit 305 has received the predetermined signal from the relay board 200.

<Right Stop Switch 13sw>

The right stop switch 13sw is provided to detect the right stop button 13 being operated by the player. When the right stop switch 13sw detects the right stop button 13 being operated by the player, the relay board 200 transmits a predetermined signal to the I/F circuit 305 in the main control board 300. Then, the main CPU 301 controls to stop the right reel 17c from spinning, based on that the I/F circuit 305 has received the predetermined signal from the relay board 200. Hereinafter, the left stop switch 11sw, the middle stop switch 12sw, and the right stop switch 13sw may be collectively referred to as “stop switches 11sw, 12sw and 13sw.”

Here, with the present embodiment, the stop switches 11sw, 12sw and 13sw can detect the stop buttons 11, 12 and 13 being turned on and off. Therefore, the stop switches 11sw, 12sw and 13sw can detect the stop buttons 11, 12 and 13 being operated by the player, that is, the stop buttons 11, 12 and 13 being turned on, and also detect the finger of the player releasing the stop buttons 11, 12 and 13, that is, the stop buttons 11, 12 and 13 are turned off after the player operates the stop buttons 11, 12 and 13.

<Medal Sensor 16s>

The medal sensor 16s is provided to detect the medal inserted into the medal insertion slot 6 passing through the selector 16. When the medal sensor 16s detects the medal successfully passing through the selector 16, the relay board 200 transmits a predetermined signal to the I/F circuit 305 in the main control board 300. Then, the main CPU 301 performs control for the medal insertion, based on that the I/F circuit 305 has received the predetermined signal from the relay board 200.

<Setting Change Switch 37sw>

The setting change switch 37 is provided to detect the setting change button 37 being operated. When the setting change switch 37sw detects the setting change button 37 being operated, the relay board 200 transmits a predetermined signal to the I/F circuit 305 in the main control board 300. Then, the main CPU 301 performs control for changing and displaying the setting value on the setting display part 36, based on that the I/F circuit 305 has received the predetermined signal from the relay board 200.

<Power-Supply Board 500>

The power-supply unit 510, the hopper 520 and an auxiliary fill-up sensor 530s are connected to the power-supply board 500.

<Power-Supply Unit 510>

The power-supply unit 510 includes a power-supply switch 511sw and a reset switch 512sw. These switches are connected to the power-supply board 500 via the power-supply unit 510.

<Power-Supply Switch 511sw>

The power-supply switch 511sw is provided to detect the power-supply button 511 being operated by a staff member of the game parlor. When the power-supply switch 511sw detects the power-supply button 511 being operated by the staff member, the power-supply board 500 transmits a predetermined signal to the I/F circuit 305 in the main control board 300. The power-supply board supplies a voltage to the entire game machine 1, based on that the power-supply switch 511sw detects the power-supply button 511 being operated by the staff member.

<Reset Switch 512sw>

The reset switch 512sw is provided to detect the reset button 512 being operated by a staff member of the game parlor. When the reset switch 512sw detects the reset button 512 being operated by the staff member, the power-supply board 500 transmits a predetermined signal to the I/F circuit 305 in the main control board 300. By this means, it is possible to stop outputting an error signal and so forth, and therefore to recover from an error state.

<Auxiliary Fill-Up Sensor 530s>

The auxiliary fill-up sensor 530s is provided to detect the number of medals accumulated in the auxiliary accumulation part 530 being above a predetermined number. When the auxiliary fill-up sensor 530s detects the number of medals accumulated in the auxiliary accumulation part 530 being above the predetermined number, the power-supply board 500 outputs a signal to indicate that the number of medals accumulated in the auxiliary accumulation part 530 is above the predetermined number, to the I/F circuit 305 in the main control board 300. Then, when the I/F circuit 305 receives the signal indicating that the number of medals accumulated in the auxiliary accumulation part 530 is above the predetermined number, the main control board 300 performs control to display a predetermined error. Then, when the error is displayed, the player calls for a staff member of the game parlor, and then the staff member collects the medals and operates the reset button 512, so that the error state is recovered to a normal state that can restart the game.

<Reel Control Board 100>

Stepping motors 101, 102 and 103, a left reel sensor 111s, a middle reel sensor 112s and a right reel sensor 113s are connected to the reel control board 100.

<Stepping Motors 101, 102 and 103>

The stepping motors 101, 102 and 103 are provided to spin the left reel 17a, the middle reel 17b and the right reel 17c, respectively. The momentum of each of the stepping motors 101, 102 and 103 is proportional to the number of pulses, and its axis of rotation can be stopped at a designated angle. The driving forces of the stepping motors 101, 102 and 103 are transmitted to the left reel 17a, the middle reel 17b and the right reel 17c, respectively, via a gear with a predetermined reduction gear ratio. By this means, the left reel 17a, the middle reel 17b and the right reel 17c spin at a predetermined angle every time a pulse is outputted to the stepping motors 101, 102 and 103. Here, the main CPU 301 controls the spin angles of the left reel 17a, the middle reel 17b and the right reel 17c by detecting the reel index and then counting the number of times the pulses are outputted to the stepping motors 101, 102 and 103.

<Left Reel Sensor 111s>

The left reel sensor ills includes an optical sensor having a light-emitting part and a light-receiving part, and is configured to detect the reel index indicating that the left reel 17a spins through 360 degrees.

<Middle Reel Sensor 112s>

The middle reel sensor 112s includes an optical sensor having a light-emitting part and a light-receiving part, and is configured to detect the reel index indicating that the middle reel 17b spins through 360 degrees.

<Right Reel Sensor 113s>

The right reel sensor 113s includes an optical sensor having a light-emitting part and a light-receiving part, and is configured to detect the reel index indicating that the right reel 17c spins through 360 degrees.

<Sub-Control Board 400>

The sub-control board 400 principally controls performances. The following components are connected to the sub-control board 400: a performance control board 410; an image control board 420; a sound control board 430; the side lamp 5; a performance button detection switch 18sw; a numerical keyboard detection switch 19sw; the performance lamps 22; the stop operation order display lamps 30; and the LED board 54. Here, with the present embodiment, in addition to the game states such as an RT game state, which are controlled by the main control board 300, there are also provided the game states such as “bonus state” and “ART state” as special game states, which are controlled by the sub-control board 400. Moreover, with the present embodiment, various performances are provided based on the states controlled by the sub-control board 400.

<Performance Button Detection Switch 18sw>

The performance button detection switch 18sw is provided to detect the performance button 18 being operated by the player. When the performance button detection switch 18sw detects the performance button 18 being operated by the player, the sub-control board 400 performs the control based on the operation of the performance button 18 by the player.

<Numerical Keyboard Detection Switch 19sw>

The numerical keyboard detection switch 19sw is provided to detect the numerical keyboard 19 being operated by the player. When the numerical keyboard detection switch 19sw detects the numerical keyboard 19 being operated by the player, the sub-control board 400 performs the control based on the operation of the numerical keyboard 19 by the player.

<Start Lever Performance Lamp 42>

The start lever performance lamp 42 includes super bright LEDs, and is provided to present a performance that appeals to the player's eyes, based on that a predetermined requirement is met. Here, the sub-control board 400 controls the lighting and blinking of the start lever performance lamp 42, based on that the predetermined requirement is met, for example, a predetermined win area is determined in internal lottery processing described later.

<Performance Control Board 410>

Primarily in a performance, the performance control board 410 controls, the side lamp 5, the performance button detection switch 18sw, the performance lamp 22, the stop operation order display lamps 30, and the start lever performance lamp 42. An I/F circuit 411, a sub-CPU 412, a random number generator 413, a sub-ROM 414 and a sub-RAM 415 are connected to the performance control board 410.

<I/F Circuit 411>

The I/F circuit 411 is provided to receive signals and so forth from the I/F circuit 305 in the main control board 300.

<Sub-CPU 412>

The sub-CPU 412 reads a performance program stored in the sub-ROM 414, performs a predetermined calculation based on a command from the main control board 300, and input signals from the performance button detection switch 18sw and the numerical keyboard detection switch 19sw, and supplies the result of the calculation to the image control board 420 and the sound control board 430.

<Random Number Generator 413>

The random number generator 413 is provided to generate random numbers that are used to determine performances presented by the LC display device 41, and the speakers 34 and 35. In addition, the random number generator 413 generates random numbers that are used for a lottery to move into an ART state, and also used to determine the number of additional games for the ART state.

<Sub-ROM 414>

The sub-ROM 414 is provided to store a program to execute performances, a performance table, an ART lottery table and so forth. The sub-ROM 414 is mainly constituted by a program storage area and a table storage area.

<Sub-RAM 415>

The sub-RAM 415 functions as a work area for data when the sub-CPU 412 performs arithmetic processing. To be more specific, the sub-RAM 415 includes a storage area for storing various data on a win area and so forth transmitted from the main control board 300, and a storage area for storing the determined performance content and performance data. The sub-RAM 415 includes an ART storage area for storing the ART state and an ART game storage area for storing the number of ART games.

<Image Control Board 420>

The image control board 420 is provided to control the display of the LC display device 41 mainly for executing a performance. The following components are connected to the image control board 420: a video display processor (VDP) 421; an LC control CPU 422a; an LC control ROM 422b; an LC control RAM 422c; a frame counter 422d; a CGROM 423; a crystal oscillator 424; a VRAM 425 and an RTC device 426.

<Video Display Processor (VDP) 421>

The video display processor (VDP) 421 is a sort of image processor, and configured to perform control to read image data from “display frame buffer area”, which is one of the first frame buffer area and the second frame buffer area, based on a command from the LC control CPU 422a. Then, the video display processor 421 generates a video signal (e.g. an LVDS signal or RGB signal) and outputs the signal to a general-purpose board 38 to display an image on the LC display device 41. Here, the video display processor (VDP) 421 includes a control register, a CG bus I/F, a CPU I/F, a clock generation circuit, an expansion circuit, a drawing circuit, a display circuit, and a memory controller (not shown). They are connected to the video display processor 421 via a bus. In addition, the video display processor 421 performs control to operate an LC drive unit 610 and a bar unit 630, based on a command from the LC control CPU 422a.

<LC Control CPU 422a>

The LC control CPU 422a is provided to create a display list based on a command received from the performance control board 410, and transmit the display list to the video display processor (VDP) 421. In addition, the LC control CPU 422a performs control to display the image data stored in the CGROM 423 on the LC display device 41.

<LC Control ROM 422b>

The LC control ROM 422b includes a mask ROM and so forth and stores a program for control processing of the LC control CPU 422a, a display list generation program, animation patterns for displaying the animation of performance patterns, animation scene information and so forth. Here, the animation patterns are referred to display the animation of a performance pattern. The LC control ROM 422b stores combinations of pieces of animation scene information included in the performance pattern and also stores the display order of the pieces of animation scene information. In addition, the animation scene information may include await frame (display time), target data (the identification number of the sprite, the source address and so forth), parameters (the display position of the sprite, the destination address and so forth), a drawing method, information that designates a display device for displaying the performance image.

<LC Control RAM 422C>

The LC control RAM 422c is built in the LC control CPU 422a. The LC control RAM 422c functions as a work area for data when the LC control CPU 422a performs arithmetic processing, and is provided to temporarily store the data read from the LC control ROM 422b.

<Frame Counter 422d>

The frame counter 422d is supplied with electric power from the power-supply board 500 to count a frame counter value. When the power-supply board 500 stops supplying electric power, the frame counter 422d stops counting the frame counter value. Then, when the power-supply board 500 resumes the supply of electric power, the frame counter 422d resets the frame counter value registered in the register and resumes counting.

<CGROM 423>

The CGROM (character generator read only memory) 423 is constituted by a flash memory, an EEPROM (electrically erasable programmable read only memory), an EPROM (erasable programmable read only memory), a mask ROM and so forth. The CGROM 423 compresses and stores image data (e.g. sprite data, movie data) constituted by a group of pixel information within a predetermined pixel range (e.g. 32×32 pixels). This pixel information is constituted by color number information designating the color number for each pixel and a value indicating the transparency of the image. In the CGROM 423, the video display processor 421 reads an image in units of image data, and image processing is performed in units of frame image data. Moreover, the CGROM 423 stores palette data in which the color number information designating the color number is associated with display color information for actually displaying the color in an uncompressed way.

Here, although with the present embodiment, the CGROM 423 stores the palette data in an uncompressed way, it is by no means limiting. Part of the pallet data may be compressed. In addition, to compress movies, various compression technologies, such as MPEG 4 are applicable.

<Crystal Oscillator 424>

The crystal oscillator 424 is provided to output a pulse signal (V-blank interrupt signal> to the video display processor 421 every “ 1/60 seconds (about 16.6 ms).” Also the video display processor 421 divides the frequency of the pulse signal to generate a system clock for the control and a synchronizing signal to synchronize with the LC display device 41. Then, upon detecting the V-blank interrupt signal, the video display processor 421 outputs a performance timing information signal to the LC control CPU 422a at a predetermined time, based on the V-blank interrupt signal.

An SRAM (Static Random Access Memory) may be used as the VRAM 425. Here, the SRAM may be a readable and writable memory and a sort of volatile memory for temporarily storing data. Since the VRAM 425 includes a SRAM, it is possible to realize the high-speed processing to write and read image data. In addition, the VRAM 425 has a memory map constituted of an optional area, a display list area 1, a display list area 2, a frame buffer area 1 and a frame buffer area 2.

<RTC Device 426>

The RTC device 426 is provided to count a predetermined count value at an interval that is different from the interval of the frame counter 422d. The RTC device 426 is connected to the LC control CPU 422a in the image control board 420 via a bus. The RTC device 426 is provided to acquire the current date and time.

<General-Purpose Board 38>

The general-purpose board 38 is provided between the image control board 420 and the LC device 41, and has a bridge function to transform image data in a predetermined format and output it for display. The bridge function of the general-purpose board 38 also can transform image data in a format to support the performance of the LC display device 41 that displays the image data. For example, it is possible to absorb the difference in resolution between when a 19-inch SXGA (1280×1024) LC display device is connected and when a 17-inch XGA (1024×768) LC display device is connected.

<Sound Control Board 430>

The sound control board 430 is provided to control the sound output of the speakers 34 and 35 mainly for executing a performance. A sound source IC 431, a sound source ROM 432, an audio RAM 433 and an amplifier 434 are connected to the sound control board 430.

<Sound Source IC 431>

The sound source IC 431 is provided to read the program and data regarding the audio from the sound source ROM 432 and to generate an audio signal to drive the speakers 34 and 35.

<Sound Source ROM 432>

The sound source ROM 432 is provided to store a program and data for executing a performance. To be more specific, the sound source ROM 432 stores an audio program and audio data.

<Audio RAM 433>

The audio RAM 433 is provided to generate sound such as BGM, based on sound data corresponding to the performance.

<Amplifier 434>

The amplifier 434 is provided to amplify an audio signal from the sound source IC 431 and outputs the amplified signal to the speakers 34 and 35.

<LC Drive Unit 610>

The LC drive unit 610 is controlled by the video display processor (VDP) 421 to move the LC display device 41. To be more specific, the LC drive unit 610 is configured to move the LC display device 41 upward and downward according to a signal inputted from the video display processer 421. The operation mechanism of the LC display device 41 by the LC drive unit 610 will be described later. Here, the LC drive unit 610 is equivalent to “second mover” recited in the appended claims.

<Bar Unit 630>

The bar unit 630 is controlled by the video display processor 421 to move the title bar 641. To be more specific, the bar unit 630 is configured to move the title bar 641 forward, backward, upward and downward according to a signal inputted from the video display processor 421. The operation mechanism of the title bar 641 by the bar unit 630 will be described later. Here, the bar unit 630 is equivalent to “mover” recited in the appended claims.

<LC Drive Unit 610 and Bar Unit 630>

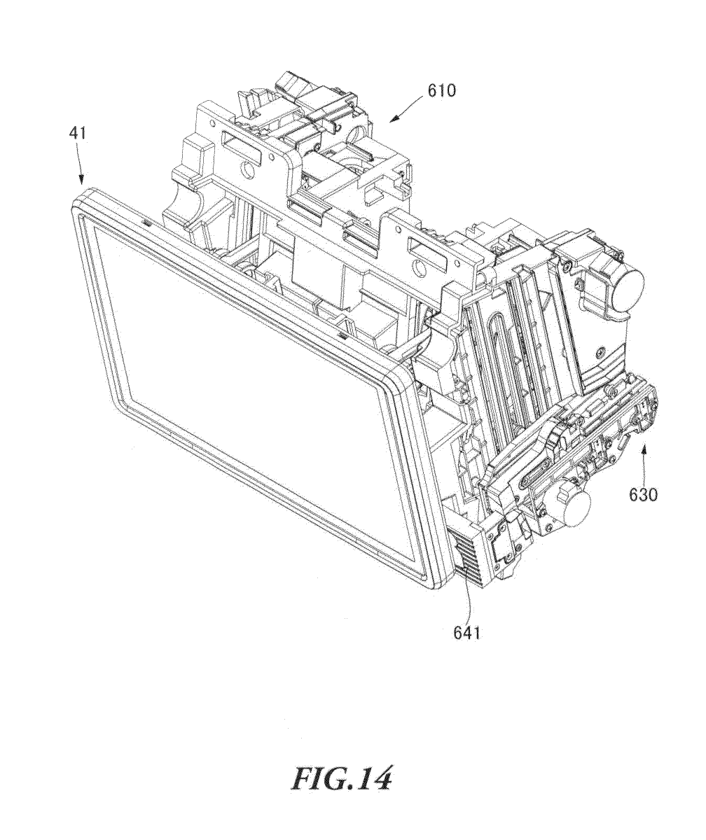

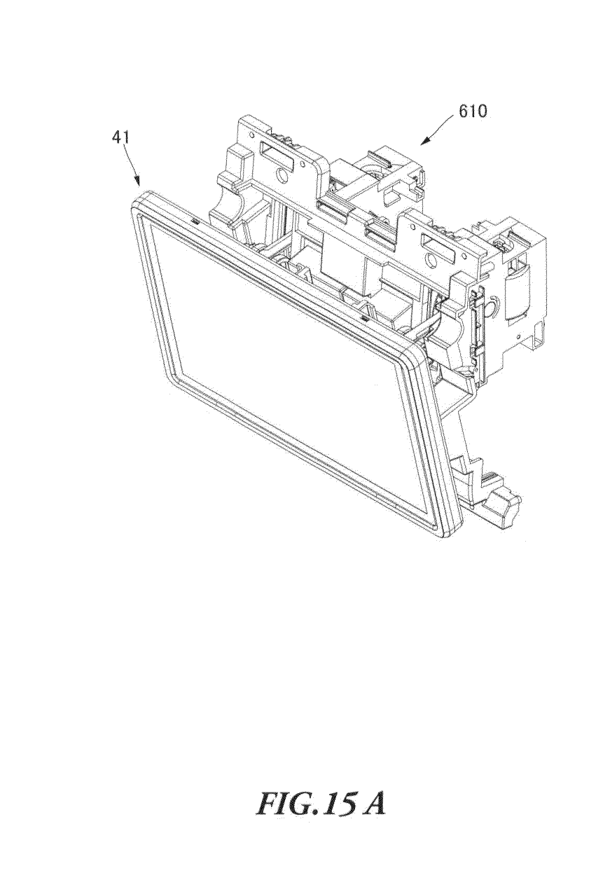

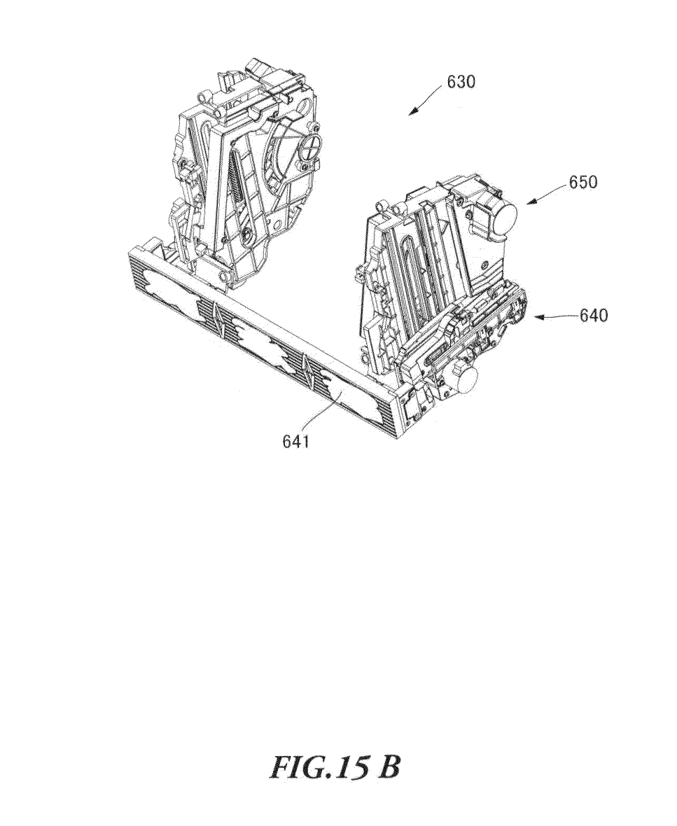

Next, the LC drive unit 610 and the bar unit 630 will be described in detail. FIG. 14 is a perspective view showing the LC display device 41, the LC drive unit 610 and the bar unit 630. FIG. 15A is a perspective view showing the LC display device 41 and the LC drive unit 630, separated from the bar unit 630; and FIG. 15B is a perspective view showing the bar unit 630, separated from the LC display device 41 and the LC drive unit 610.

As shown in FIG. 14, FIG. 15A and FIG. 15B, the LC drive unit 610 is provided on the back surface of the LC display device 41. The bar unit 630 is provided to sandwich the LC drive unit 610, and the title bar 641 is located on the lower part of the back surface of the LC display device 41. With this arrangement, the title bar 641 is covered (hidden) by the LC display device 41 and cannot be seen from the player side in the default state. Here, as described later, the bar unit 630 includes a bar forward and backward drive unit 640 and a bar upward and downward drive unit 650.

<Primary Parts of LC Display Device 41 and LC Drive Unit 610>

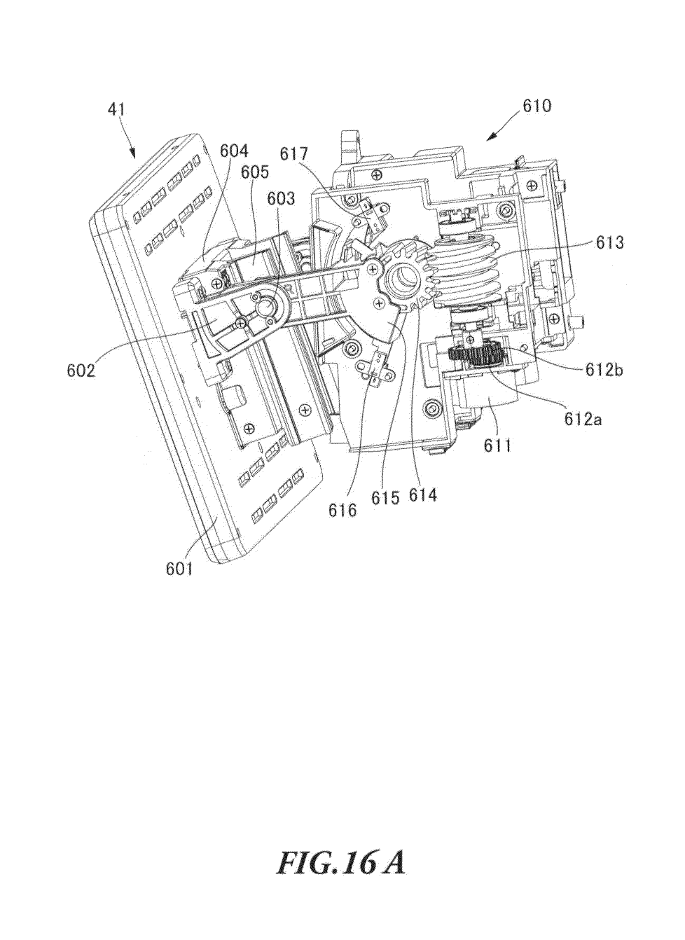

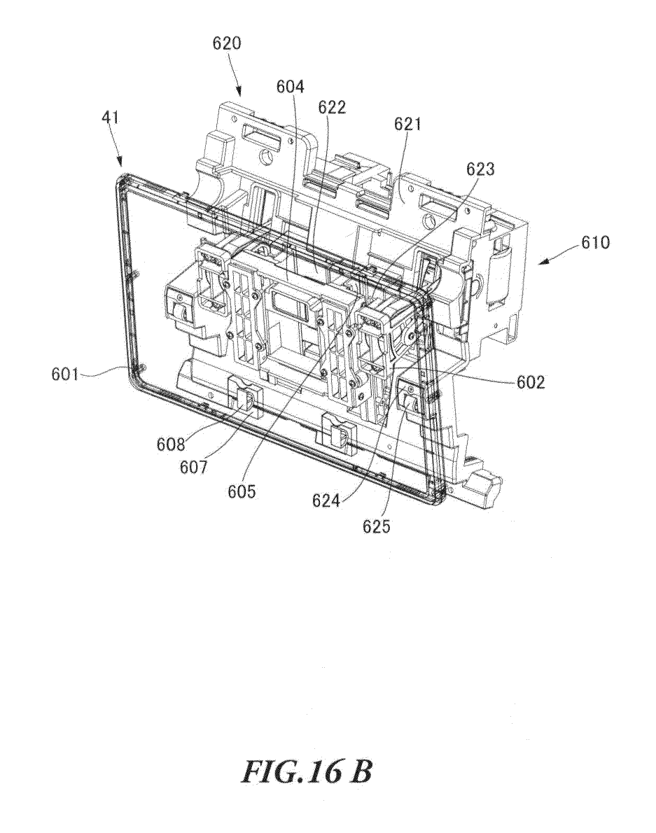

Next, primary parts of the LC drive unit 610 will be described with reference to FIGS. 16A and 16B. FIG. 16A is a perspective view showing primary parts of the LC display device 41 and the LC drive unit 610 from one side. FIG. 16B is a perspective view showing the primary parts of the LC display device 41 and the LC drive unit 610 from the front side. Here, FIG. 16B shows the LC drive unit 610 through the LC part of the LC display device 41.

As shown in 16B, the LC display device 41 is slidably mounted to a mechanism mounting base unit 620 fixed to the front door 3 of the game machine 1. Here, the mechanism mounting base unit 620 is omitted from FIG. 16A in order to explain the drive mechanism of the LC drive unit 610.

Here, the mechanism mounting base unit 620 includes an LC mobile mechanism mounting base 621, a rail base 622, a slide rail 623, roller covers 624 and rollers 625.

The LC mobile mechanism mounting base 621 is fixed to the front door 3, and the LC display device 41 and the LC drive unit 610 are attached to the LC mobile mechanism mounting base 621. The rail base 622 is fixed to the LC mobile mechanism mounting base 621. The slide rail 623 is mounted to the rail base 622 and holds the LC display device 41 to be able to slide.

The roller cover 624 is fixed to the LC mobile mechanism mounting base 621 and has an opening. The roller 625 is accommodated in the roller cover 624 and pivotally supported. Part of the roller 625 protrudes from the opening of the roller cover 624 and contacts the LC display device 41. A set of the roller cover 624 and the roller 625 is provided symmetrically in each of the left and right sides of the LC display device 41.

Next, the LC display device 41 will be described in detail. The LC display device 41 includes an LC case 601, LC bearings 602, an LC arm pin 603, a rail base 604, a slide rail 605, roller covers 607 and rollers 608.

The LC case 601 accommodates an LC display that displays images. The LC bearings 602 are fixed to the back surface side of the LC case 601. A pair of the LC bearings 602 is provided symmetrically in each of the left and right sides of the back surface of the LC case 601. Here, the left LC bearing 602 and the right LC bearing 602 are the same as one another, so that only the LC bearing 602 that is in the right side, viewed from the front of the game machine 1, will be described.

Likewise, hereinafter, when a pair of symmetric members is provided, only the right member will be described.

The front end of the LC bearing 602 branches into two, and sandwiches an LC drive arm 615 of the LC drive unit 610 therebetween.

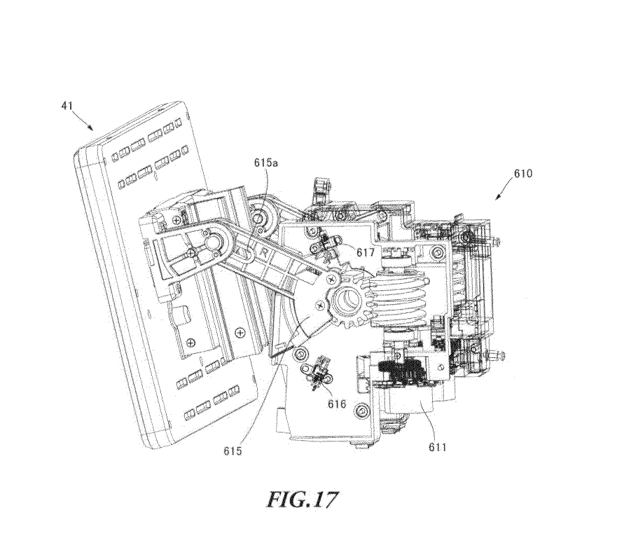

The LC arm pin 603 penetrates a long hole 615a (see FIG. 17) provided in each of the LC drive arms 615a, and fixed to the LC bearings 602 at each end. By this means, the LC display device 41 is held to be able to move in the long axis direction of the long hole 615a of each of the LC drive arm 615.

The rail base 604 is fixed to the LC case 601. The slide rail 605 is fixed to the rail base 604. In addition, the slide rail 605 in the LC side and the slide rail 623 in the mechanism mounting base unit 620 make a pair and can slide the LC display device 41 only in the direction in which the slide rail 605 in the LC side and the slide rail 623 in the base side extend. Hereinafter, the direction in which the slide rail 605 in the LC side and the slide rail 623 in the base side extend may be referred to as “slide direction.”

The bearing cover 607 is fixed to the back surface of the LC case 601 and has an opening. The roller 608 is accommodated in the roller cover 607 and pivotally supported. Part of the roller 608 protrudes from the opening of the roller cover 607 and contacts a guide base (not shown). Here, this guide base is parallel to the back surface of the LC case 601 and has a flat surface extending in the above-described slide direction. Here, the roller 608 in the LC side is mounted so as not to overlap the roller 625 in the base side.

A pair of the LC rollers 608 is provided symmetrically in the right and left sides of the LC case 601. In addition, it is preferred that the center of the plurality of rollers 608 in the LC side and the center of the LC bearings 602 are arranged with respect to the center of gravity of the LC case 601 including the LC display. Here, the number of the rollers 608 in the LC side is not limited, but one or three or more is possible.

Also, a pair of the rollers 625 in the mechanism mounting base unit 620 is provided symmetrically in the right and left sides of the LC case 601, like the rollers 608. In addition, it is preferred that the center of the plurality of rollers 625 in the base side and the center of the LC bearings 602 are arranged with respect to are arranged with respect to are arranged with respect to the center of gravity of the LC case 601 including the LC display. Here, the number of the rollers 625 in the base side is not limited, but one or three or more is possible, in the same way as the rollers 608 in the LC side.

With this arrangement of the rollers 608 in the LC side and the rollers 625 in the base side, it is possible to maintain a certain distance between the LC case 601 and the mechanism mounting base unit 602 and to smoothly move the LC display device 41 in the slide direction without leaning.

<LC Drive Unit 610>

The LC drive unit 610 includes an LC drive motor 611, a first LC link gear 612a, a second LC link gear 612b, an LC drive worm gear 613, an LC drive arm gear 614, an LC drive arm 615, a first LC photo sensor 616, and a second LC photo sensor 617.

The LC drive motor 611 is controlled by the video display processor 421 and rotated. The first LC link gear 612 is constituted by two gears, a large gear and a small gear. Here, the large gear is provided in the lower part of the first LC link gear 612a, and the small gear is provided in the upper part. The large gear of the first LC link gear 612a engages with the shaft of the LC drive motor 611. By this means, the first LC link gear 612a is rotated by the LC drive motor 611.

The second LC link gear 612b engages with the small gear of the first LC link gear 612a. By this means, the second LC link gear 612b is rotated by the first LC link gear 612a.

The LC drive worm gear 613 is concentrically fixed to the second LC link gear 612b. By this means, the LC drive worm gear 613 is rotated along with the rotation of the second LC link gear 612b. In addition, the LC drive worm gear 613 is a kind of worm gear and has an outer periphery with a spiral groove.

Meanwhile, the LC drive arm gear 614 has an outer periphery with a gear-like shape and engages with the spiral groove of the LC drive worm gear 613. Therefore, when the LC drive worm gear 613 rotates, the outer periphery of the LC drive arm gear 614 is moved together in the vertical direction, so that the LC drive arm gear 614 is rotated.

The LC drive arm 615 has a first end that is fixed to the outer periphery of the LC drive arm gear 614 and a second end having the above-described long hole 615a. As described above, the LC arm pin 603 of the LC display device 41 penetrates the long hole 615a of each of the LC drive arms 615, so that it is possible to support the LC display device 41 to be able to move in the long axis direction of the long hole 615a.

The first end of the LC drive arm 615 is fixed to the outer periphery of the LC drive arm gear 614, and therefore when the LC drive arm gear 614 rotates, the LC drive arm 615 rotates along with the LC drive arm gear 614. That is, the second end of the LC drive arm 615 moves around the same axis as the LC drive arm gear 614 in a circular motion.

The first LC photo sensor 616 includes a light transmitting part that transmits a light signal and a light receiving part that receives light. Part of the movement path of the LC drive arm 615 passes through between the light transmitting part and the light receiving part of the first LC photo sensor 616 to detect the default position of the CL drive arm 615.

The second LC photo sensor 617 includes a light transmitting part that transmits a light signal and a light receiving part that receives light. Part of the movement path of the LC drive arm 615 passes through between the light transmitting part and the light receiving part of the second LC photo sensor 617 to detect the maximum position limit of the CL drive arm 615.

With this arrangement of the first LC photo sensor 616 and the second LC photo sensor 617, it is possible to detect the movement state of the LC drive arm 615, that is, to detect the position to which the LC display device 41 has moved.

With the above-described configuration, when the video display processor 421 rotates the LC drive motor 611, the first LC link gear 612a is rotated and then the second LC link gear 612b is rotated. When the second LC link gear 612b is rotated, the LC drive worm gear 613 rotates, so that the LC drive arm gear 614 is rotated to move the second end of the LC drive arm 615 in the circular motion.

When the second end of the LC drive arm 615 is moved in the circular motion, the force is applied to the LC display device 41 accordingly. At this time, the LC display device 41 is allowed to move only in the slide direction, so that the LC arm pin 603 moves through the long hole 615a of the LC drive arm 615 to move the LC display device 41 in the slide direction.

FIG. 17 is a perspective view showing the LC display device 41 after being moved upward and the LC drive unit 610. As shown in FIG. 17, the LC display device 41 is moved by the LC drive arm 615 of the LC drive unit 610, from the default position to an upper position in the slide direction.

In addition, the first LC photo sensor 616 and the second LC photo sensor 617 can detect the position to which the LC display device 41 has been moved. Here, the LC display device 41 can be stopped or turned back on the way from the bottom position, as the default position, to the top position. Here, the bottom position which is the default position and the top position are equivalent to “predetermined position” and “second predetermined position” recited in the appended claims, respectively.

<Bar Unit 630>

Next, primary parts of the bar unit 630 will be described. As described above, the bar unit 630 includes the bar forward and backward drive unit 640 and the bar upward and downward drive unit 650.

<Bar Forward and Backward Drive Unit 640>

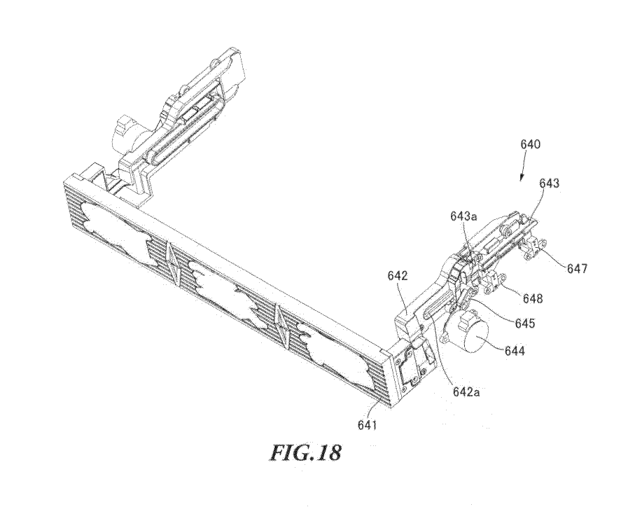

First, the bar forward and backward drive unit 640 will be described. FIG. 18 is a perspective view showing the bar forward and backward drive unit 640.

As shown in FIG. 18, the bar forward and backward drive unit 640 includes the title bar 641, a bar forward and backward slider 642, a bar forward and backward arm guide 643, a bar forward and backward drive motor 644, a bar forward and backward arm 645, a first bar forward and backward photo sensor 647 and a second bar forward and backward photo sensor 648.

The title bar 641 is a gimmick that can move according to a predetermined requirement. The bar forward and backward slider 642 is connected to the title bar 641 to move together with the title bar 641. The bar forward and backward slider 642 has a long hole 642a in the forward and backward direction of the game machine 1.

A bar roller holder 661 of the bar upward and downward drive unit 650 is fitted into the long hole 642a of the bar forward and backward slider 642, and therefore is supported to be able to move in the long axis direction of the long hole 642a but not to be able to move in the minor axis direction. That is, the bar forward and backward slider 642 moves in an approximately forward and backward direction but in an approximately upward and downward direction of the game machine 1, with respect to the bar roller holder 661. In other words, the bar forward and backward slider 642 moves together with the bar roller holder 661.

The bar forward and backward arm guide 643 is fixed to the bar forward and backward slider 642 to move together with the bar forward and backward slider 642 and the title bar 641. The bar forward and backward arm guide 643 has a concave portion 643a as a vertical hole.

The bar forward and backward drive motor 644 is controlled by the video display processor 421 and rotated. The bar forward and backward arm 645 is fixed to the bar forward and backward drive motor 644 and rotated by the bar forward and backward drive motor 644. The front end of the bar forward and backward arm 645 is fitted into the concave portion 643a of the bar forward and backward arm guide 643. Therefore, when the bar forward and backward arm 645 rotates, the front end of the bar forward and backward arm 645 moves upward and downward in the concave portion 643a of the bar forward and backward arm guide 643 to move the bar forward and backward arm guide 643 forward and backward.

The first bar forward and backward photo sensor 647 includes a light transmitting part that transmits a light signal and a light receiving part that receives light. Part of the movement path of the bar forward and backward arm guide 643 passes through between the light transmitting part and the light receiving part of the first bar forward and backward photo sensor 647 to detect the default position of the bar forward and backward arm guide 643.

The second bar forward and backward photo sensor 648 includes a light transmitting part that transmits a light signal and a light receiving part that receives light. Part of the movement path of the bar forward and backward arm guide 643 passes through between the light transmitting part and the light receiving part of the second bar forward and backward photo sensor 648 to detect the maximum position limit of the bar forward and backward arm guide 643.

With this arrangement of the first bar forward and backward photo sensor 647 and the second bar forward and backward photo sensor 648, it is possible to detect the movement state of the bar forward and backward arm guide 643, that is, to detect the position to which the title bar 641 has been moved forward or backward.

With the above-described configuration, when the bar forward and backward drive motor 644 is rotated by the video display processor 421, the bar forward and backward arm 645 is rotated. Accordingly, the bar forward and backward arm guide 643 is moved in the forward and backward direction, and therefore the bar forward and backward slider 642 and the title bar 641 which are integrated with the bar forward and backward arm guide 643 are moved in the forward and backward direction. Therefore, the bar forward and backward drive motor 644 is rotated by the video display processor 421, so that it is possible to move the title bar 641 in the forward and backward direction.

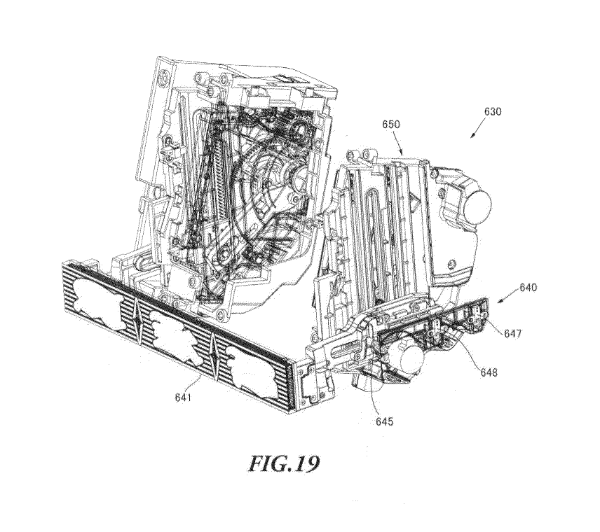

FIG. 19 is a perspective view showing the title bar 641 after being moved forward and the bar unit 630. As shown in FIG. 19, the title bar 641 is moved by the bar forward and backward arm 645 of the bar forward and backward drive unit 640, from the default position to a forward position.

In addition, the first bar forward and backward photo sensor 647 and the second bar forward and backward photo sensor 648 can detect the position to which the title bar 641 has been moved. Here, the title bar 641 can be stopped or turned back on the way from the back position, as the default position, to the front position. The back position (i.e. default position) is equivalent to “first position” recited in the appended claims.

<Bar Upward and Downward Drive Unit 650>

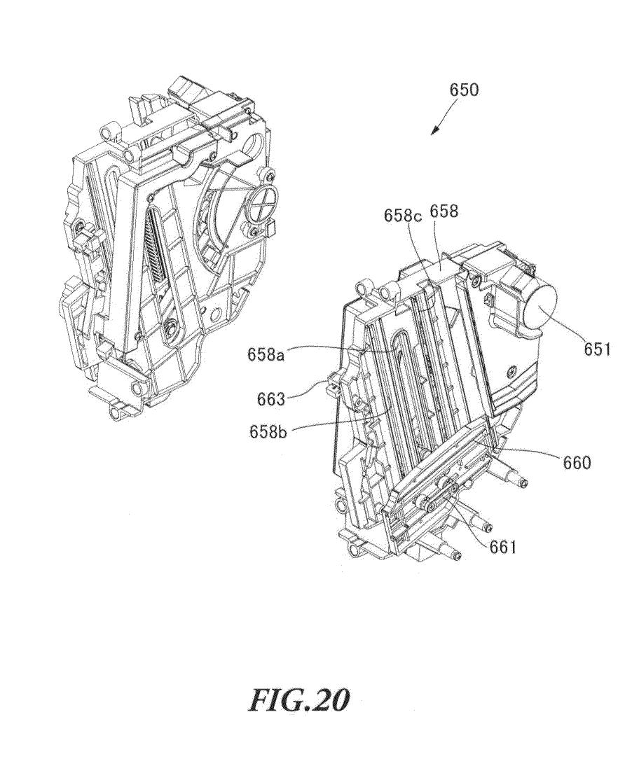

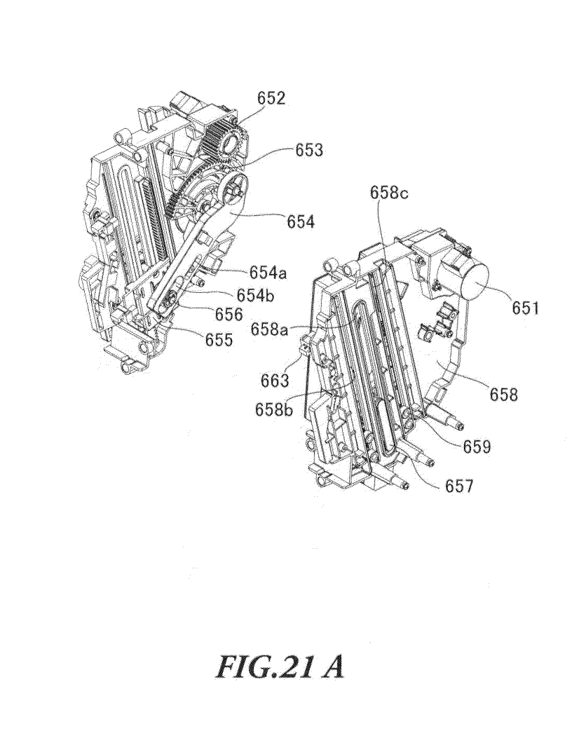

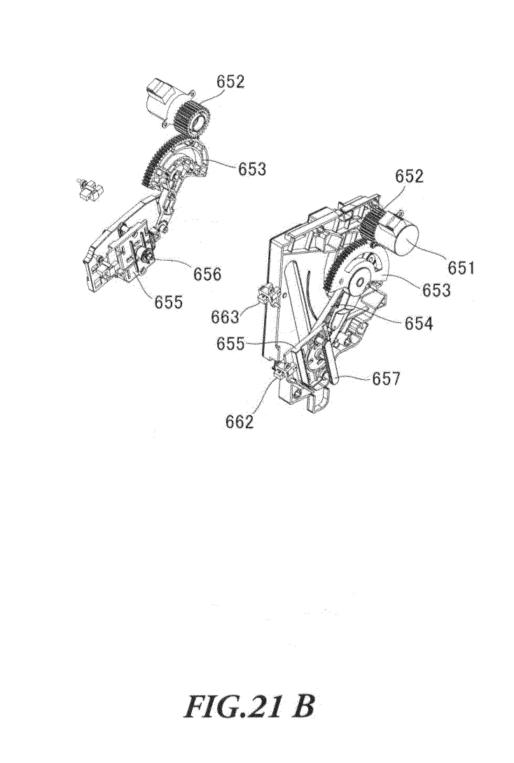

Next, primary parts of the bar upward and downward drive unit 650 will be described. FIG. 20 is a perspective view showing the bar upward and downward drive unit 650. FIGS. 21A and 21B are drawings each showing part of the exploded bar upward and downward drive unit 650.

As shown in FIG. 20 and FIGS. 21A and 21B, the bar upward and downward drive unit 650 includes a bar upward and downward drive motor 651, a bar upward and downward motor gear 652, a bar upward and downward cam gear 653, a bar upward and downward arm 654, a bar arm link 655, a bar upward and downward guide bush 656, a bar slide bush 657, a bar upward and downward guide base 658, a bar link shaft 659, a bar upward and downward plate 660, a bar roller holder 661, a first bar upward and downward photo sensor 662 and a second bar upward and downward photo sensor 663.

The bar upward and downward drive motor 651 is controlled by the video display processor 421 and rotated. The bar upward and downward motor gear 652 is an external gear and has the central axis fixed to the shaft of the bar upward and downward drive motor 651. By this means, the bar upward and downward motor gear 652 is rotated along with the rotation of the bar upward and downward drive motor 651.

The bar upward and downward cam gear 653 includes an outer periphery having a semicircular gear part with external teeth engaging with the bar upward and downward motor gear 652; and an arm part that has the same axis as the gear part and extends in the direction opposite to the gear part. In addition, the front end of the arm part of the bar upward and downward cam gear 653 has a protrusion. When the bar upward and downward motor gear 652 rotates, this protrusion of the arm part of the bar upward and downward cam gear 653 moves in a circle.

The bar upward and downward arm 654 has an arm-like shape and is pivotally supported at one end. In addition, the bar upward and downward arm 654 includes a long holes 654a and 654b. In the part of the bar upward and downward arm 654 from the center to the front end, the long hole 654a is formed near the center and the long hole 654b is formed near the front end. Moreover, the protrusion of the bar upward and downward cam gear 653 is fitted into the long hole 654a of the bar upward and downward arm 654.

By this means, when the protrusion of the bar upward and down ward cam gear 653 moves in a circle around the shaft of the bar upward and downward cam gear 653, the bar upward and downward arm 654 rotates on its axis.

The bar arm link 655, the bar upward and downward guide bush 656, and the bar slide bush 657 move together in an approximately vertical direction. The bar upward and downward bush 656 is attached to the bar arm link 655 and fitted into the long hole 654b of the bar upward and downward arm 654.

The bar slide bush 657 is formed of a rectangle with rounded corners and has each end attached to the bar arm link 655. Here, the rectangle with rounded corners means a rectangle whose narrow sides are formed of semicircles. Here, the shape of the bar slide bush 657 is not limited to a rectangle with rounded corners, but a rectangle, an ellipse and another shape may be applicable.

In addition, the bar slide bush 657 is fitted into a long hole 658a of the bar upward and downward guide base 658 such that the long axis direction of the corner-rounded rectangle matches the long axis direction of the long hole 658a. The long hole 658a of the bar upward and downward guide base 658 has a long axis in an approximately vertical direction.

By this means, when the bar upward and downward arm 654 rotates on its axis, the bar upward and downward guide bush 656 moves together with the bar upward and downward arm 654 and the bar slide bush is allowed to move only in the vertical direction, so that the bar arm link 655 moves in an approximately vertical direction.

The bar upward and downward guide base 658 accommodates the bar upward and downward motor gear 652, the bar upward and downward cam gear 653, the bar upward and downward arm 654, the bar arm link 655, the bar upward and downward guide bush 656 and the bar slide bush 657. In addition, the long hole 658a is formed in a side surface of the bar upward and downward guide base 658 such that its long axis is in an approximately vertical direction. Moreover, a long hole 658b and a long hole 658c are formed in the side surface of the bar upward and downward guide base 658 on each side of the long hole 658a in parallel.

A bar link shaft 659 is mounted to the bar arm link 655. The bar link shaft 659 includes four bar link shafts, bar link shafts 659a, 659b, 659c, and 659d. The bar link shafts 659a and 659b penetrate the long hole 658b of the bar upward and downward guide base 658. Meanwhile, the bar link shafts 659c and 659d penetrate the long hole 658c of the bar upward and downward guide base 658.

The bar upward and downward plate 660 is fixed to the bar link shaft 659. That is, the bar upward and downward plate 660 is fixed to the bar arm link 655 via the bar link shaft 659, and therefore moves upward and downward when the bar arm link 655 moves upward and downward.

The bar roller holder 661 is mounted to the bar upward and downward plate 660. The bar roller holder 661 is formed of a rectangle with rounded corners. Here, like the bar slide bush 657, the shape of the bar roller holder 661 is not limited to the rectangle with rounded corners but another shape may be applicable.

Moreover, as described above, the bar roller holder 661 is fitted into the long hole 642a of the bar forward and backward slider 642 in the bar unit 630. By this means, when the bar upward and downward plate 660 moves upward and downward, the bar roller holder 661 follows this upward and downward movement to move the bar forward and backward slider 642 upward and downward. Consequently, when the bar upward and downward plate 660 moves upward and downward, and therefore the bar unit 630 moves upward and downward together with the movement of the bar upward and downward plate 660. That is, the title bar 641 moves upward and downward according to the upward and downward movement of the bar upward and downward plate 660.

The first bar upward and downward photo sensor 662 includes a light transmitting part that transmits a light signal and a light receiving part that receives light. Part of the movement path of the bar arm link 655 passes through between the light transmitting part and the light receiving part of the first bar forward and backward photo sensor 662 to detect the default position of the bar arm link 655.

The second bar upward and downward photo sensor 663 includes a light transmitting part that transmits a light signal and a light receiving part that receives light. Part of the movement path of the bar arm link 655 passes through between the light transmitting part and the light receiving part of the second bar upward and downward photo sensor 663 to detect the maximum position limit of the bar arm link 655.

With this arrangement of the first bar upward and downward photo sensor 662 and the second bar upward and downward photo sensor 663, it is possible to detect the movement state of the bar arm link 655, that is, to detect the position to which the title bar 641 has been moved upward or downward.

With the above-described configuration, when the bar upward and downward drive motor 651 is rotated by the video display processor 421, the bar upward and downward motor gear 652 is rotated, so that the bar upward and downward cam gear 653 is rotated. Subsequently, when the bar upward and downward cam gear 653 is rotated, the protrusion formed on the front end of the arm part of the bar upward and downward cam gear 653 is moved in a circle, and therefore the bar upward and downward arm 654 is rotated.

When the bar upward and downward arm 654 is rotated, the bar arm link 655 with the bar upward and downward guide bush 656 is moved upward and downward. Next, the bar upward and downward plate 660, which is fixed to the bar arm link 655 via the bar link shaft 659, is moved upward and downward along with the upward and downward movement of the bar arm link 655. When the bar upward and downward plate 660 is moved upward and downward, the bar roller holder 661 mounted to the bar upward and downward plate 660 is moved upward and downward, so that the bar unit 630 is moved upward and downward together with them.

Therefore, when the bar upward and downward drive motor 651 is rotated by the video display processor 421, the bar unit 630 is moved upward and downward, that is, it is possible to move the title bar 641 in the vertical direction.

Here, as described above, when the bar forward and backward drive motor 644 is rotated by the video display processor 421, it is possible to move the title bar 641 forward and backward, so that it is possible to move the title bar 641 forward, backward, upward and downward by the control of the video display processor 421.

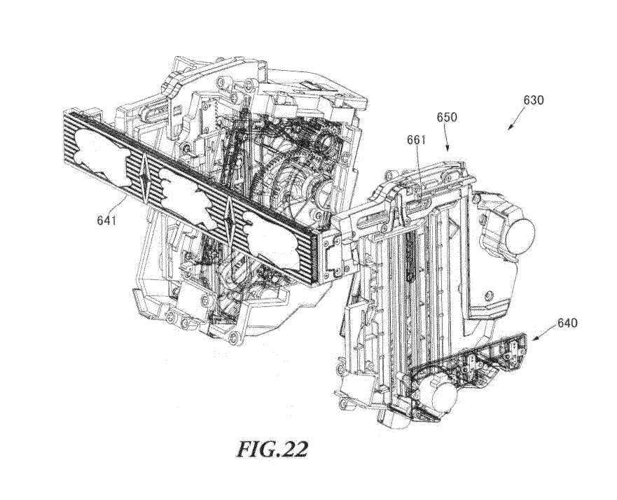

FIG. 22 is a perspective view showing the title bar 641 after being moved upward and the bar unit 630. As shown in FIG. 22, the title bar 641 is moved by the bar roller holder 661 of the bar upward and downward drive unit 650, from the default position to an upper position.

In addition, the first bar upward and downward photo sensor 662 and the second bar upward and downward photo sensor 663 can detect the position to which the title bar 641 has been moved. Here, the title bar 641 can be stopped or turned back on the way from the bottom position, as the default position, to the top position. Here, the top position is equivalent to “second position” recited in the appended claims.

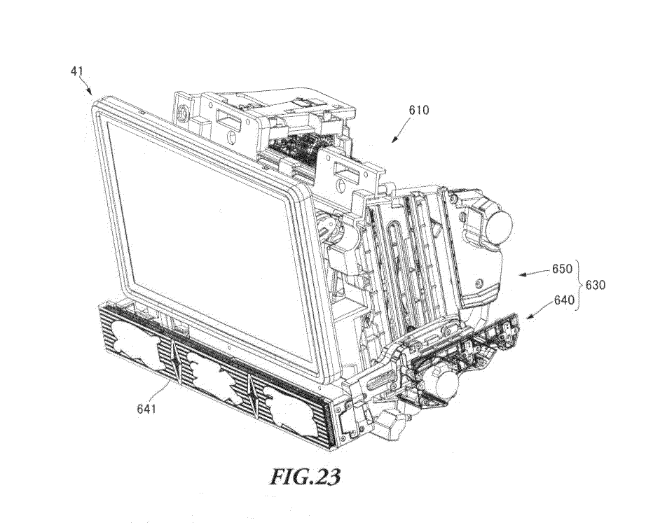

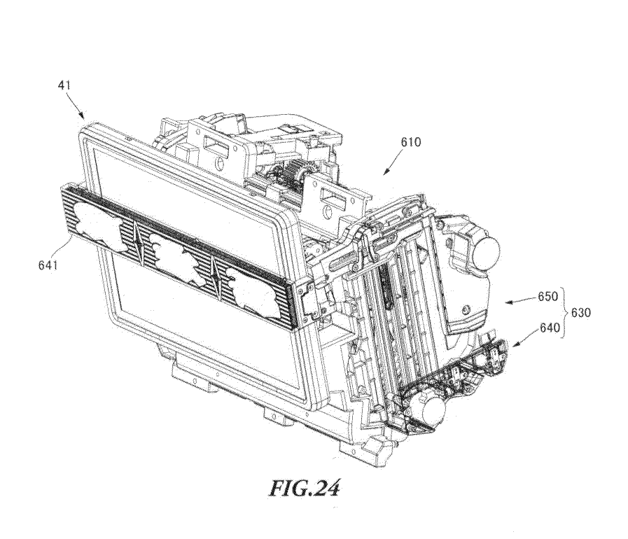

FIG. 23 and FIG. 24 show exemplary combinations of the movements of the LC display device 41 and the title bar 641.

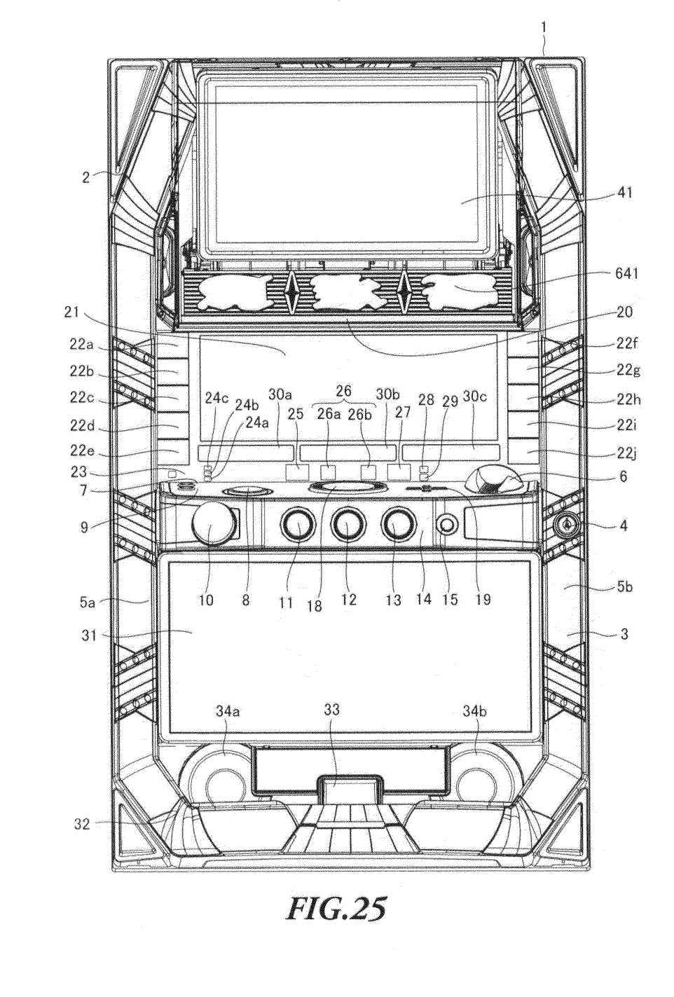

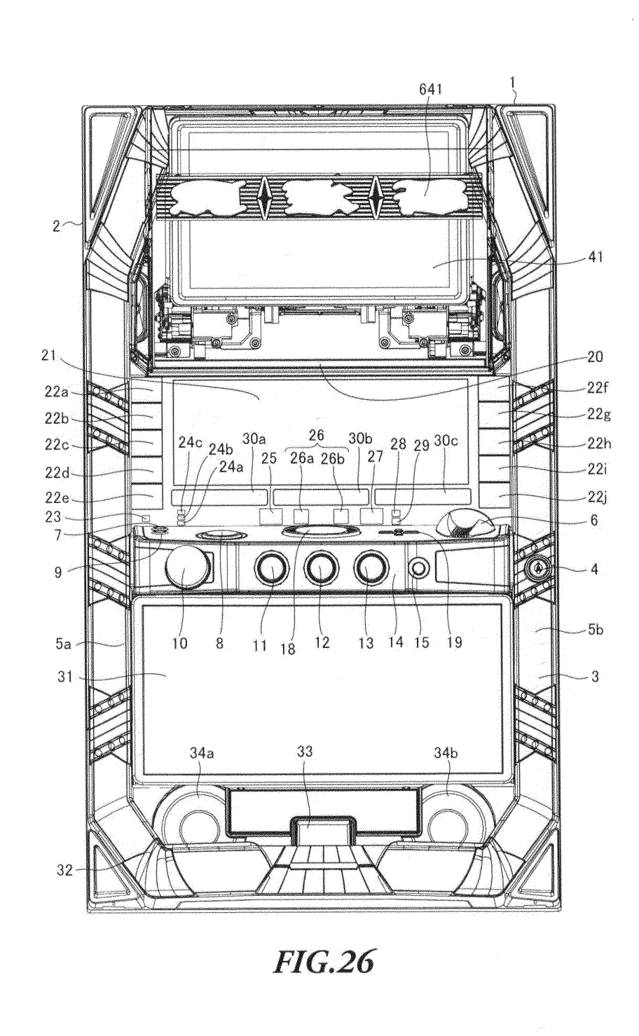

FIG. 23 is a perspective view showing the LC display device 41 after being moved upward and the title bar 641 after being moved forward. FIG. 24 is a perspective view showing the LC display device 41 after being moved upward and the title bar 641 after being moved forward and upward. FIGS. 25 and 26 are drawings each show the entire game machine 1 after the LC display device 41 and the title bar 641 are moved. FIG. 25 is a front view showing the game machine 1 after the LC display device 41 is moved upward and the title bar 641 is moved forward. FIG. 26 is a front view showing the game machine 1 after the LC display device 41 is moved upward and the title bar 641 is moved forward and upward. Here, the combinations of the movements of the LC display device 41 and the title bar 641 are not limited to them.

As described above, the LC display device 41 and the title bar 641 can be moved in various ways by the LC drive unit 610 and the bar unit 630 which are controlled by the video display processor 421.

<Symbol Arrangement Table>

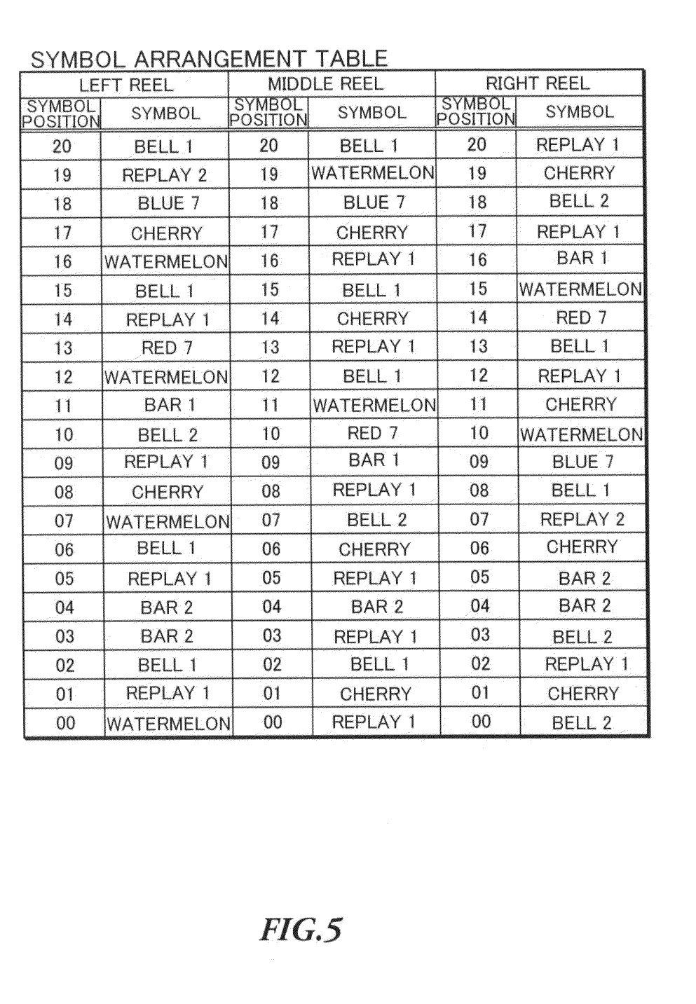

Next, a symbol arrangement table will be described with reference to FIG. 5.

The symbol arrangement table is provided in the main ROM 302. When the main CPU 301 detects the reel index, the position of the symbol displayed in the middle stage of the display window 21 is defined as “00” in the symbol arrangement table. “00” to “20” corresponding to the symbol counter are allocated to the symbols, respectively, in the order of the spinning direction of the reels, beginning from the symbol position “00”.

Symbols are allocated to the reels according to the symbol arrangement table shown in FIG. 5. When a predetermined combination of the symbols is arranged on the pay line, various prizes such as payout of medals, a replay and a bonus game, are provided to the player. For example, when bell 1, bell 1 and bell 1 are arranged on the pay line, nine medals are paid out; when replay 1, replay 1 and replay 1 are arranged on the pay line, a replay is activated; and when red 7, red 7 and red 7 are arranged on the pay line, a predetermined number of bonus games (for example, twenty games) are activated.

Here, in a bonus state in which bonus games are performed, the stop operation order display lamps 30a to 30c inform the order to operate the stop buttons 11, 12 and 13 during the predetermined number of games, in order to arrange the symbol combination associated with “bell”. That is, the stop buttons 30a to 30c are operated according to the informed order of stop operations, so that the player can acquire many medals for a short period of time.

In addition, with the present embodiment, for example, it is determined whether or not the game will progress to an ART state after the bonus state ends, and determined how many ART games will be performed. Then, when it is determined that the game will progress to an ART state, the ART games will be performed the determined number of times.

In the ART game, the order of stop operations is informed to stop the symbol combination associated with “bell” on the pay line; and the acquisition of a replay is high as long as the stop buttons 11, 12 and 13 are operated according to the informed order of stop operations. That is, in the ART state, it is possible to acquire many medals without the consumption of medals.

Here, with the present embodiment, in a case in which the number of ART games is determined, the number of games to be added to the number of ART games is determined by a lottery and so forth, provided that predetermined same symbols (bells) are arranged on the pay line. As described in detail later, with the present embodiment, when the additional number is determined, a predetermined performance (“super exciting performance” described later) will be determined.

<Performance Determination Table>

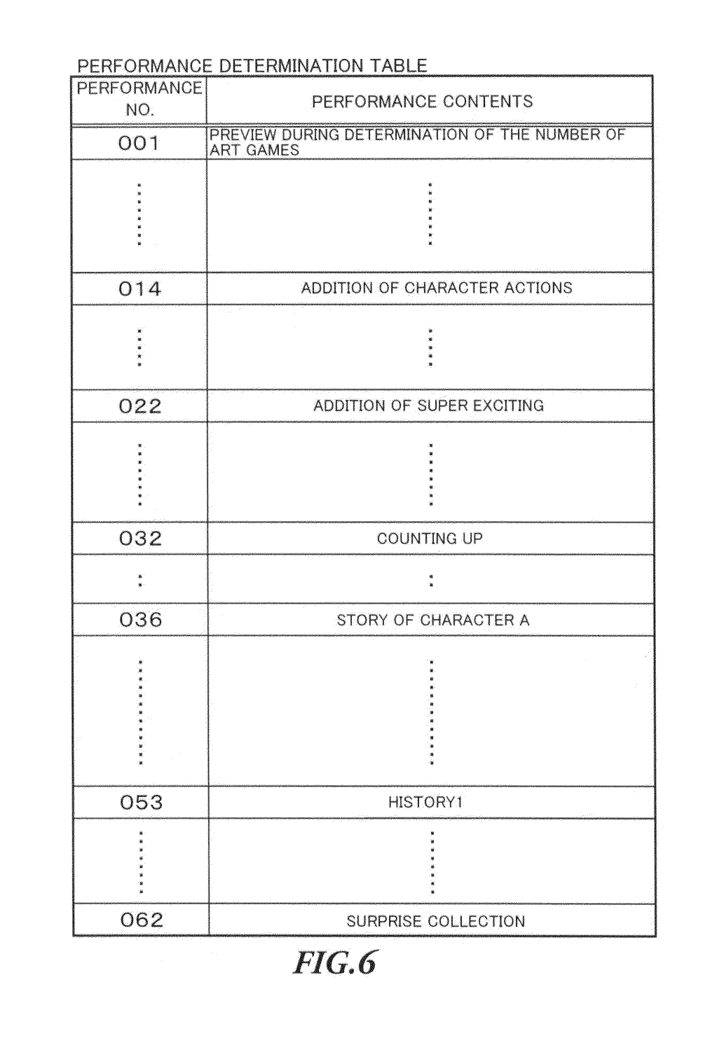

Next, the performance determination table will be described with reference to FIG. 6.

FIG. 6 shows the performance determination table provided in the sub-ROM 414. The sub-control board 400 determines various performances by using the performance determination table and controls the performances.

With the present embodiment, for example, “super exciting performance” listed as “performance No. 022” is performed when additional games are added to the number of ART games. When “super exciting performance” is started, the player is prompted to push the performance button 18 according to the display. At this time, when the performance button 18 is pushed by the player, the LC drive unit 110 is activated to move the LC display device 41 upward and downward. Then, information about the added number of ART games is displayed on the LC display device 41 (for example, “+10 games” is displayed). Also, at this time, the speakers 34 and 35 output sounds (e.g. fanfare) to inform that the additional games have been added to the number of ART games. Moreover, when the player pushes the performance button 18 pushes, the title bar 641 that is separated from the LC display device 41 and provided on the back surface side of the LC display device 41 is activated by the bar unit 630, and protrudes in front of the LC display device 41. Then, the protruding title bar 641 moves upward to cover part of the image displayed on the LC display device 41, and then moves downward. After that, the added number of ART games is displayed on the LC display device 41 (for example, “+10 games” is displayed). At this time, the speakers 34 and 35 output sounds (e.g. fanfare) to inform that the additional games have been added to the number of ART games.

Combinations of the movements of the LC display device 41 and the title bar 641 are, for example, as follows:

1. Only the LC display device 41 moves upward and downward;
2. LC display device 41 moves upward while the title bar 641 moves forward;
3. The LC display device 41 moves upward while the title bar 641 moves forward, and then moves upward and downward;
4. the LC display device 41 moves upward while the title bar 641 moves forward, and the LC display device 41 moves upward and downward with the upward and downward movement of the title bar 641;
5. The LC display device 41 moves upward while the title bar 641 placed in the front side moves upward and downward; and
6. The LC display device 41 moves upward, and then moves upward and downward with the upward and downward movement of the title bar 641 placed in front of the LC display device 41.

However, it is by no means limiting, but other combinations are possible.

In addition, both the LC display device 41 and the title bar 641 may stop and change the moving direction in the middle of the range of movement, as well as they move from end to end of the range of movement. Moreover, other performances than “performance No. 022.” may be provided with the LC display device 41 and the title bar 641. Moreover, a performance may be provided with the LC display device 41 and the title bar 641 when the game progresses to a predetermined game state, or when a predetermined condition is realized. Furthermore, a kind of performances with the LC display device 41 and the title bar 641 may be determined based on a selected performance or condition.

<Program Start Processing in the Main Control Board 300>

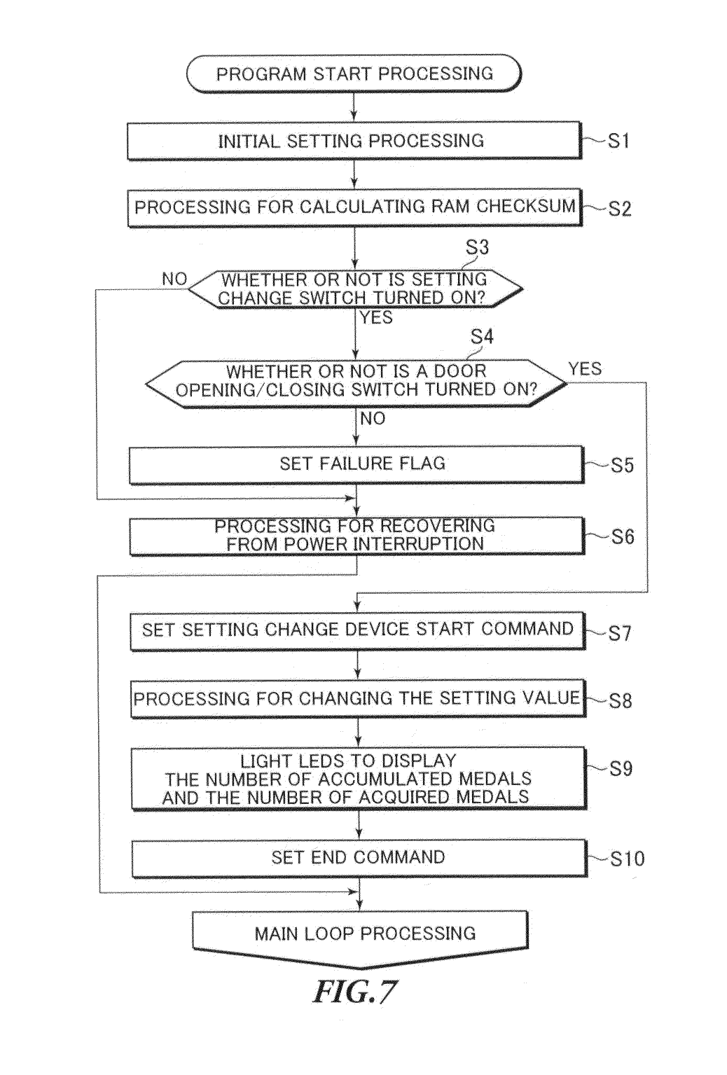

Next, program start processing in the main control board 300 will be described with reference to FIG. 7. Here, the program start processing is performed based on that the power-supply switch 511sw is turned on.

<Step S1>

In step S1, the main CPU 301 performs initial setting processing. To be more specific, the initial setting processing is performed to set the address of the table for setting the internal register of the game machine 1 and also set the address of the register, based on the table. Then, after the processing in the step S1 ends, the step moves to step S2.

<Step S2>

In the step S2, the main CPU 301 performs processing for calculating RAM checksum. To be more specific, the main CPU 301 performs the processing for calculating the checksum of the main RAM 303 and setting the calculated checksum of the main RAM 303. Here, the checksum is a kind of error detecting code. Then, after the processing in the step S2 ends, the step moves to step S3.

<Step S3>

In the step S3, the main CPU 301 performs processing for determining whether or not the setting change switch is turned on. With the present embodiment, the setting change switch is turned on by turning a setting change key inserted into the key hole (not shown) for a predetermined angle. Therefore, in the step S3, the main CPU 301 determines whether or not the setting change key (not shown) is turned for a predetermined angle while the setting change key is inserted into the key hole. Then, when it is determined that the setting change switch is turned on (step S3=Yes), the step moves to step S4. On the other hand, when it is determined that the setting change switch is turned off (step S3=No), the step moves to step S6.

<Step S4>

In the step S4, the main CPU 301 determines whether or not a door opening/closing switch is turned on. With the present embodiment, the dedicated key is inserted into the key hole 4 and turned for a predetermined angle, and the front door 3 opens for a predetermined angle or more, so that the door opening/closing switch is turned on. Therefore, in the step S4, the main CPU 301 performs processing for determining whether or not the dedicated key is inserted into the key hole 4 and turned for a predetermined angle, and the front door is open for a predetermined angle or more. Then, when it is determined that the door opening/closing switch is turned on (step S4=Yes), the step moves to step S7. On the other hand, when it is determined that the door opening/closing switch is turned off (step S4=No), the step moves to step S5.

<Step S5>

In the step S5, the main CPU 301 sets a failure flag. To be more specific, when the setting change switch is turned on (step S3=Yes) and the door opening/closing switch is turned off (step S4=No), the setting change key instated into the key hole has been turned for a predetermined angle despite that the front door 3 is not open for a predetermined angle or more. In this case, the main CPU 301 sets the failure flag in a failure flag storage area provided in the main RAM 303. Then, after the processing in the step 5 ends, the step moves to the step S6.

<Step S6>

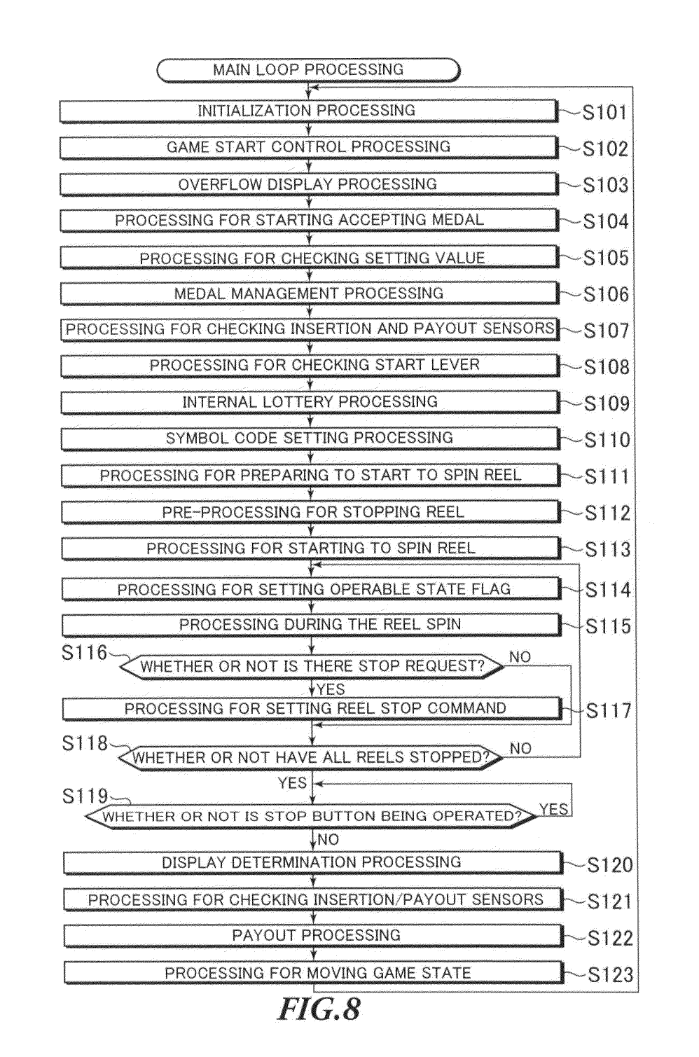

In the step S6, the main CPU 301 performs processing for recovering from power interruption. To be more specific, when the power supply to the game machine 1 is resumed after interrupting the power supply to the game machine 1, the main CPU 301 performs processing for recovering the saved register value and the saved stack pointer value. In addition, the processing for recovering from power interruption includes processing for initializing the main RAM 303. Then, after the processing in the step S6 ends, the processing moves to main loop processing shown in FIG. 8.

<Step S7>

In step S7, the main CPU 301 performs processing for setting a setting change device start command. To be more specific, when the setting change switch is turned on (step S3=Yes), and the door opening/closing switch is turned on (step S4=Yes), the main CPU 301 performs processing for setting the setting change device start command in a performance transmission data storage area in the main RAM 303, in order to transmit the setting change device start command to the sub-control board 400. Here, the setting change device start command has information indicating the start of the setting change of the game machine 1. Then, after the processing in the step S7 ends, the step moves to step S8.

<Step S8>

In the step S8, the main CPU 301 performs processing for changing the setting value. To be more specific, the main CPU 301 acquires the current setting value, and determines whether or not the range of the setting value is correct. Here, when it is determined that the range is correct, the main CPU 301 performs processing for displaying the current setting value on the accumulated medal number display 25 and the setting display part 36. On the other hand, when it is determined that the range is not correct, the main CPU 301 sets the default setting value in the setting value storage area provided in the main RAM 303, and then performs processing for displaying the default setting value on the accumulated medal number display 25 and the setting display part 36. Then, the main CPU 301 performs processing for changing and displaying the setting value, based on that the setting change switch 37sw detects the setting change button 37 being operated; processing for fixing the setting value, based on the start switch 10sw detects the start lever 10 being operated; and processing for storing the setting value in the setting value storage area in the main RAM 303, based on that it is detected that the setting change key having been turned for a predetermined angle is being turned to the angle to allow the key to be taken out. Then, after the processing in the step S8 ends, the step moves to step S9.

<Step S9>

In the step S9, the main CPU 301 performs processing for lighting LEDs to display the number of accumulated medals and the number of acquired medals. To be more specific, the main CPU 301 commands to the accumulated medal number display 25 and the payout number display 27 to display the number of the accumulated medals and the number of the medals to be paid out. Here, the accumulated medal number display 25 and the payout number display 27 are connected to the relay board 200 via the I/F circuit 305. Then, after the processing in the step S9 ends, the step moves to step S10.

<Step S10>

In the step S10, the main CPU 301 performs processing for setting an end command to end the setting change device. To be more specific, the main CPU 301 performs the processing for setting the end command in the performance transmission data storage area in the main RAM 303, in order to transmit the end command to the sub-control board 400. Here, this end command to end the setting change device has information indicating that the setting value has been changed and information regarding the changed setting value. Then, after the processing in the step S10 ends, the processing moves to the main loop processing shown in FIG. 8.

<Main Loop Process>

Next, main loop processing will be described with reference to FIG. 8.

<Step S101>

In step S101, the main CPU 301 performs initialization processing. To be more specific, the main CPU 301 performs the processing for setting a stack pointer and initializing the main RAM 303. Then, when the processing in the step S101 ends, the step moves to step S102.

<Step S102>

In the step S102, the main CPU 301 performs game start control processing. To be more specific, the main CPU performs the processing for clearing the number of medals to be paid out and setting the current game state. Then, when the processing in the step S102 ends, the step moves to step S103.

<Step S103>

In the step S103, the main CPU 301 performs overflow display processing. To be more specific, the main CPU 301 performs the processing for predetermined error display by the payout number display 27 via the relay board 200, based on that the auxiliary fill-up sensor 530s detects the auxiliary accumulation part 530 being filled up with the medals. Then, when the processing in the step S103 ends, the step moves to step S104.

Here, with the present embodiment, the predetermined error display is performed by the payout number display 27. However, it is by no means limiting, but another display device or lamp may be used. For example, information may be provided by a plurality of devices such as the payout number display 27, the LC display device 41 and so forth.

<Step S104>

In the step S104, the main CPU 301 performs processing for starting accepting a medal. During the processing, the main CPU 301 performs processing for allowing a medal to be accepted when a replay is not activated. Then, when the processing in the step 104 ends, the step moves to step S105. Here, the processing for starting accepting a medal may include, for example, processing for adding the inserted medal number counter by insertion of an additional medal, and setting an automatic insertion command at the time of a replay.

<Step S105>

In the step S105, the main CPU 301 performs processing for checking the setting value. To be more specific, the main CPU 301 performs the processing for reading the setting value that was stored in the setting value storage area in the main RAM 303 in the step S10. Then, when the processing in the step S105 ends, the step moves to step S106.

<Step S106>

In the step S106, the main CPU 301 performs medal management processing. During this process, the main CPU 301 performs processing for checking if a medal is inserted. Then, when the processing in the step S106 ends, the step moves to step S107. Here, this medal management processing includes, for example, processing for checking if a correct medal is inserted into the medal insertion slot 6 and processing for adjust the medals at the medal adjustment time.

<Step S107>

In the step S107, the main CPU 301 performs processing for checking insertion/payout sensors. In this processing, the main CPU 301 performs processing for displaying a failure when the medal sensor 16s or a payout sensor (not shown) provided in the hopper 520 detects the failure. Then, when the processing in the step 107 ends, the step moves to step S108. Here, this processing for checking the insertion/payout sensors may include processing for determining whether or not the medal sensor 16s detects a failure, and processing for determining whether or not the payout sensor (not shown) provided in the hopper 520 detects a failure.

<Step S108>

In the step S108, the main CPU 301 performs processing for checking the start lever. This processing may include, for example, processing for determining whether or not the start switch 10sw is turned on. Then, when the processing in the step S108 ends, the step moves to step S109. Here, this processing for checking the start lever may include processing for determining whether or not the operation of the start lever 10 is acceptable. When it is determined that the operation of the start lever 10 is acceptable, the operation of the start lever 10 is allowed to be accepted.

<Step S109>

In the step S109, the main CPU 301 performs internal lottery processing. This processing includes the processing for determining whether or not a bonus, a small win, or a replay can be acquired through a lottery. Then, when the processing in the step 109 ends, the step moves to step S110. Here, this internal lottery processing may include acquiring data such as the current game state, the number of lotteries in the current game and the kind of RT.

<Step S110>

In step S110, the main CPU 301 performs symbol code setting processing. This processing includes processing for holding a lottery to determine whether or not to perform a reel spin performance, based on the win area determined in the step S109. Then, when the processing in the step S110 ends, the step moves to step S111.

<Step S111>

In the step S111, the main CPU 301 performs processing for preparing to start to spin the reels. This processing includes processing for setting the time for at least one game. Then, when the processing in the step S111 ends, the step moves to step S112. Here, this processing also includes processing for determining whether or not the value of the timer counter set in the previous game has become “0”. Here, the timer counter value may be set to the time for at least one game (about 4.1 seconds). In addition, the processing for preparing to start to spin the reels may include processing for setting the waiting time until the spin speed of the reels 17 is constant.

<Step S112>

In step S112, the main CPU 301 performs pre-processing for stopping the reels. This processing includes processing for shifting the symbol stop position during which the reels 17 are spinning. Then, when the processing in the step S112 ends, the step moves to step S113. Here, this processing for shifting the symbol stop position includes processing for setting the initial value of a virtual stop position to acquire the priorities of the symbols; and processing for correcting the stop position when the stop position is not “00”, and saving the priorities.

<Step S113>

In the step S113, the main CPU 301 performs processing for starting to spin the reels 17. To be more specific, the main CPU 301 performs the processing for spinning the reels 17 at a constant speed by driving the stepping motors 101, 102 and 103 via the reel control board 100. Then, when the processing in the step S113 ends, the step moves to step S114.

<Step S114>

In the step S114, the main CPU 301 performs processing for setting an operable state flag. To be more specific, the main CPU 301 performs the processing for turning on operable state flags in operable state flag storage areas provided in the main RAM 303. Here, the operable state flag areas are provided corresponding to the stop buttons 11, 12 and 13, respectively. In addition, the operable state flags are used to determine whether or not the stop buttons 11, 12 and 13 can perform stop operation. For example, when all the operable state flags respectively corresponding to the stop buttons 11, 12 and 13 are turned off, the main CPU 301 determines that all the stop buttons 11, 12 and 13 can perform stop operation. Then, when the processing in the step S114 ends, the step moves to step S115.

<Step S115>

In the step S115, the main CPU 301 performs processing for which the reels 17 are spinning. This processing includes processing for controlling to stop the spin of the corresponding reel 17, based on that the stop switch 11sw, 12sw and 13sw detects the player operating the stop button 11, 12 and 13. Then, when the processing in the step S115 ends, the step moves to step S116.

<Step S116>

In the step S116, the main CPU 301 performs processing for determining whether or not there is a stop request. To be more specific, the main CPU 301 performs the processing for determining whether or not the stop switches 11sw, 12sw and 13sw detected the player operating the stop buttons 11, 12 and 13, so that the spinning reels 17s were stopped in the step 115. Then, when it is determined that there is no stop request (step S116=No), the step moves to step S118. On the other hand, it is determined that there is a stop request (step S116=Yes), the step moves to step S117.

<Step S117>

In the step S117, the main CPU 301 performs processing for setting a reel stop command. To be more specific, the main CPU 301 performs the processing for setting a reel stop command in the performance transmission data storage area in the main RAM 303, in order to transmit the reel stop command to the sub-control board 400. Here, the reel stop command includes information on the kind of the stopped reel 17; information on the symbol position at the time the stop switches 11sw, 12sw and 13sw detect the player operating the stop buttons 11, 12 and 13; and information on the symbol code corresponding to the symbol position. Then, when the processing in the step S117 ends, the step moves to step S118.

<Step S118>

In the step S118, the main CPU 301 performs processing for determining whether or not all the reels 17 have stopped. To be more specific, the main CPU 301 performs the processing for determining whether or not all the reels 17 have stopped, based on the value of the operable state flag storage area provided in the main RAM 303. Then, when it is determined that part of the reels 17 has not stopped yet (step S118=No), the step moves to the step S114, and the processing is repeatedly performed until all the reels 17 have stopped. On the other hand, when it is determined that all the reels 17 have stopped (step S118=Yes), the step moves to step S119.

<Step S119>

In the step S119, the main CPU 301 determines whether or not the stop buttons 11, 12 and 13 are being operated. To be more specific, the main CPU 301 performs the processing for determining whether or not the stop switches 11sw, 12sw and 13sw have been turned off. Then, when it is determined that the stop buttons 11, 12 and 13 are being operated (step S119=Yes), the processing in the step S119 is repeatedly performed until the stop buttons 11, 12 and 13 have not been operated. On the other hand, when it is determined that the stop buttons 11, 12 and 13 are not being operated (step S119=No), the step moves to step S120.

<Step S120>

In the step S120, the main CPU 301 performs display determination processing. This processing includes processing for calculating the number of medals to be paid out, according to the combination of the symbols for the win. Then, the processing in the step S120 ends, the step moves to step S121.

Here, this processing may include processing for setting a replay activation command at the time of the display of the replay, processing for calculating the number of medals to be paid out, and processing for determining a failure of the display determination.

<Step S121>

In the step S121, the main CPU 301 performs processing for checking the insertion/payout sensors. In this processing, when the medal sensor 16s or a payout sensor (not shown) provided in the hopper 520 detects a failure, the main CPU 310 performs processing for displaying the detected failure, in the same way as in the step S107. Then, when the processing in the step 121 ends, the step moves to step S122.

<Step S122>

In the step S122, the main CPU 301 performs payout processing. This processing includes processing for paying out the medals by driving the hopper 520 via the power-supply board 500. Then, when the processing in the step S122 ends, the step moves to step S123.

Here, this payout processing may include processing for determining whether or not the value of an accumulated medal number counter is “50”. Here, when the value is smaller than “50”, medals are added, and, on the other hand, when the number of the medal accumulation is greater than “50” during the addition, the medals for greater than “50” are paid out.

<Step S123>

In the step S123, the main CPU 301 performs processing for moving the game state. This processing includes processing for moving the RT game state, based on the combination of the symbols arranged on the pay line. Then, when the processing in the step S123 ends, the step moves to the step S101, and subsequent processing is repeatedly performed.

<Interrupt Processing>

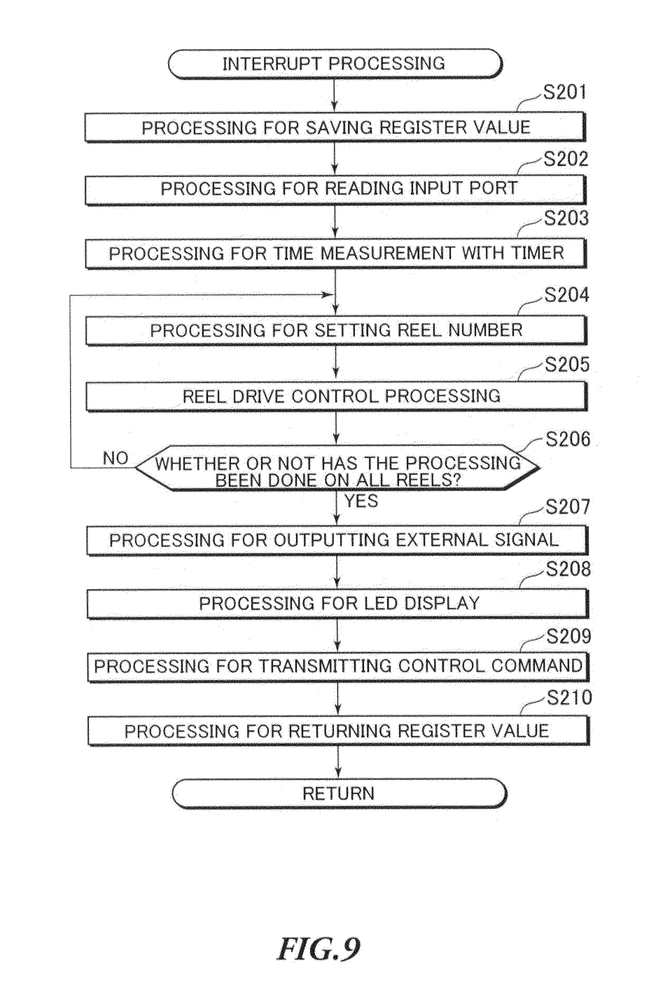

Next, interrupt processing will be described with reference to FIG. 9. Here, “interrupt processing” is performed to interrupt the main loop processing every 1.49 ms. Here, FIG. 9 shows a sub-routine of the interrupt processing.

<Step S201>

In step S201, the main CPU 301 performs processing for saving the register value. To be more specific, the main CPU 301 performs the processing for saving the register value at the time of the step S201. Then, when the processing in the step S201 ends, the step moves to step S202.

<Step S202>

In the step S202, the main CPU 301 performs processing for reading the input port. To be more specific, the main CPU 301 performs the processing to receive signals from the reel control board 100, the relay board 200, and the power-supply board 500 via the I/F circuit 305. Then, when the processing in the step S202 ends, the step moves to step S203.

<Step S203>

In the step S203, the main CPU 301 performs processing for time measurement with the timer. To be more specific, the main CPU 301 performs the processing for subtracting “one” from the value of the timer counter used to measure the spin time for the reel spin performance and the time for at least one game. Then, when the processing in the step S203 ends, the step moves to step S204.

<Step S204>

In the step S204, the main CPU 301 performs processing for setting the reel number. To be more specific, the main CPU 301 performs the processing for setting the reel number in order to set the reel targeted for reel drive control processing in step S205 described later. Then, when the processing in the step S204 ends, the step moves to step S205.

<Step S205>

In the step S205, the main CPU 301 performs reel drive control processing. To be more specific, the main CPU 301 drives the stepping motor of the reel corresponding to the reel number set by the processing in the step S204, via the reel control board 100 to control the speed of the reel 17, that is, to perform acceleration control, constant-speed control and deacceleration control. In addition, the main CPU 301 performs processing for controlling the reels 17 to spin in the opposite direction during the reel spin performance. Then, when the processing in the step S205 ends, the step moves to step S206.

<Step S206>

In the step S206, the main CPU 301 performs processing for determining whether or not the processing has been done on all the reels. To be more specific, the main CPU 301 performs the processing for determining whether or not the reel drive control processing in the step S205 has been done on all the reels 17. Then, when it is determined that the processing has been done on all the reels (step 206=Yes), the step moves to step S207. On the other hand, it is determined that the processing has not been done on part of the reels (step S206=No), the step moves to the step S204, and the same processing is repeatedly performed until the processing has been done on all the reels.

<Step S207>

In step S207, the main CPU 301 performs processing for outputting an external signal. For example, the main CPU 301 performs the processing for outputting data indicating the game state to a terminal board (not shown). Then, when the processing in the step 207 ends, the step moves to step S208.

<Step S208>

In the step S208, the main CPU 301 performs processing for LED display. To be more specific, the main CPU 301 performs the processing for controlling the lighting of the start lamp 23, the bet lamps 24a to 24c, the accumulated medal number display 25, the game state display lamp 26, the payout number display 27, the insertion possible display lamp 28, and the replay display lamp 29. Then, when the processing in the step S208 ends, the step moves to step S209.

<Step S209>

In the step S209, the main CPU 301 performs processing for transmitting a control command. To be more specific, the main CPU 301 performs the processing for transmitting various commands set in the performance transmission data storage area provided in the main RAM 303, to the sub-control board 400. Then, when the processing in the step S209 ends, the step moves to step S210.

<Step S210>

In the step S210, the main CPU 301 performs processing for returning the register value. To be more specific, the main CPU 301 performs the processing for returning the saved register value. Then, when the processing in the step zS210 ends, the main CPU 301 terminates the interrupt processing and returns to the main loop processing.

<Main Processing in the Sub-Control Board>

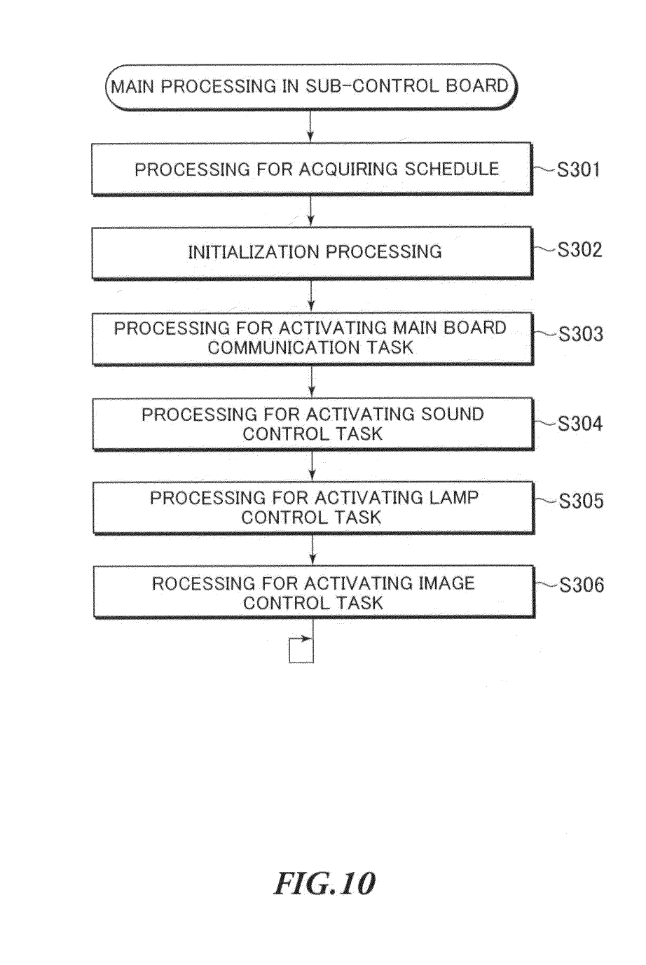

Next, the main processing in the sub-control board will be described with reference to FIG. 10. Here, the main processing in the sub-control board is performed based on that the power-supply switch 511sw is turned on.

<Step S301>

In step S301, the sub-CPU 421 performs processing for acquiring the schedule. This processing may include the processing for loading date information acquired by the RTC device 426. Then, the sub-CPU 412 determines whether or not the current date is a specific day, based on the loaded date information and so forth. When it is determined that the current date is the specific day, the sub-CPU 412 performs processing for acquiring the schedule corresponding to the date information. When the processing in the step S310 ends, the sub-CPU 412 moves the step to step S302.

<Step S302>

In the step S302, the sub-CPU 412 performs initialization processing. To be more specific, the sub-CPU 412 performs the processing for checking an error of the sub-RAM 415 and for initializing the task system. Then, when the processing in the step S302 ends, the step moves to step S303.

<Step S303>

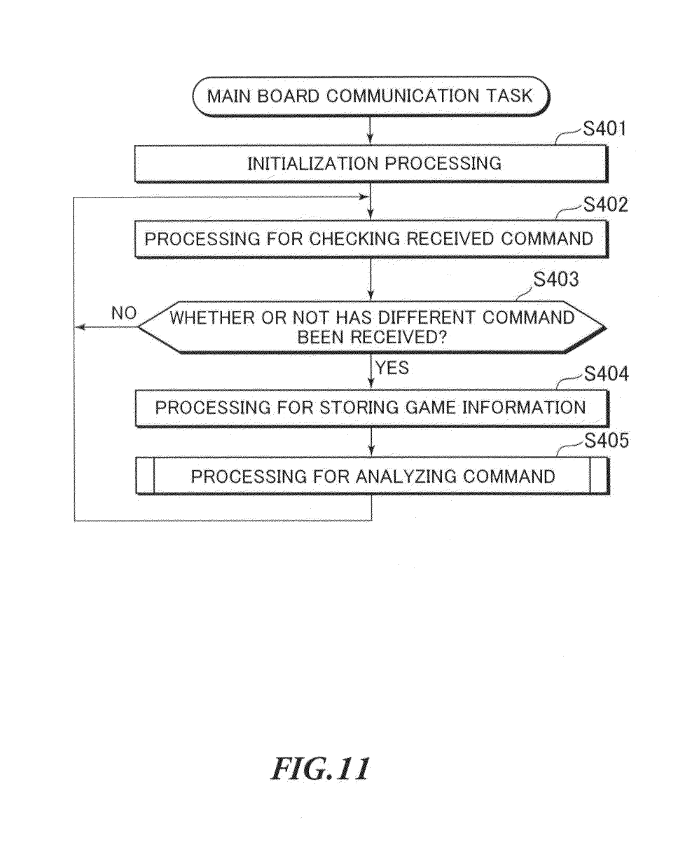

In the step S303, the sub-CPU 412 performs processing for activating a main board communication task. To be more specific, the sub-CPU 412 performs the processing for activating the main board communication task in order to perform the processing shown in FIG. 11. Then, when the processing in the step S303, the step moves to step S304.

<Step S304>

In the step S304, the sub-CPU 412 performs processing for activating a sound control task. Here, during this sound control task, the sub-CPU 412 performs processing for analyzing the sound data determined in the processing for determining sound data in step S405-3 described later (see FIG. 22), and controlling the sound outputted from the speakers 34 and 35, based on the result of the analysis. Then, when the processing in the step S304, the step moves to step S305.

<Step S305>

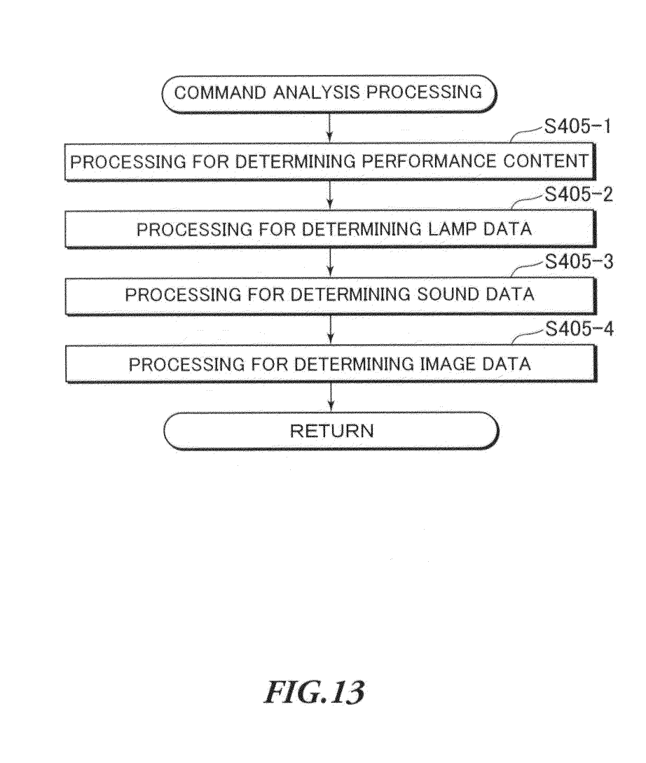

In the step S305, the sub-CPU 412 performs processing for activating a lamp control task. Here, in this lamp control task, the sub-CPU 412 analyzes lamp data determined in processing for determining lamp data in S405-2 described later (see FIG. 13), and performs processing for controlling the lighting of the side lamp 5, the performance lamp 22, the stop operation order display lamps 30, and the start lever performance lamp 42, based on the result of the analysis. Then, when the processing in the step S305 ends, the step moves to step S306.

<Step S306>

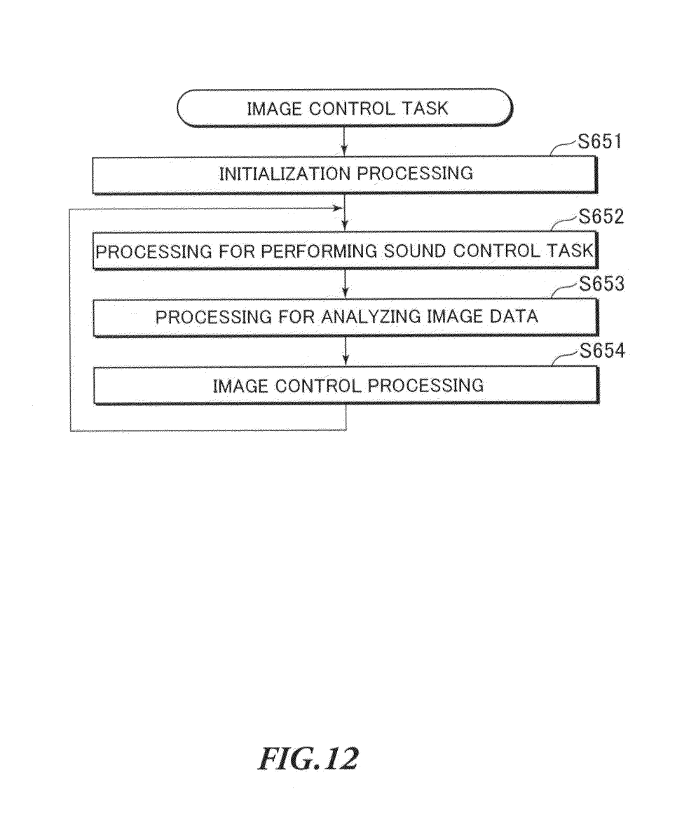

In the step S306, the sub-CPU 412 performs processing for activating an image control task. To be more specific, the sub-CPU 412 performs processing for activating the image control task in order to execute the processing shown in FIG. 12.

<Main Board Communication Task>

Next, the main board communication task will be described with reference to FIG. 20.

<Step S401>

In step S401, the sub-CPU 412 performs initialization processing. To be more specific, the sub-CPU 412 performs processing for initializing a predetermined storage area in the sub-RAM 415. Then, when the processing in the step S401 ends, the step moves to step S402.

<Step S402>

In the step S402, the sub-CPU 412 performs processing for checking a received command. To be more specific, the sub-CPU 412 performs the processing for checking the command transmitted form the I/F circuit 305 in the main control board 300 to the I/F circuit 411. Then, when the processing in the step S402 ends, the step moves to step S403.

<Step S403>

In the step S403, the sub-CPU 412 performs processing for determining whether or not a different command has been received. To be more specific, the sub-CPU 412 performs the processing for determining whether or not the command transmitted from the I/F circuit 305 in the main control board 300 is different from the command previously transmitted. Then, when it is determined that the received command is different from the previous one (step S403=Yes), the step moves to step S404. On the other hand, when it is determined that a different command has not been received (step S403=No), the step moves to the step S402.

<Step S404>

In the step S404, the sub-CPU 412 performs processing for storing game information. To be more specific, the sub-CPU 412 performs processing for generating game information based on the command checked by the processing in the step S402 and storing the information in the sub-RAM 415. By this processing, the information contained in the parameter of the command inputted from the I/F circuit 305 in the main control board 300 to the I/F circuit 411 is stored in the sub-RAM 415. Therefore, the sub-control board 400 can control the information that is controlled also in the main control board 300. Then, when the processing in the step S404 ends, the step moves to step S405.

In the step S405, the sub-CPU 412 performs command analysis processing, which will be described later with reference to FIG. 13. This processing includes the processing corresponding to the command inputted from the I/F circuit 305 in the main control board 300 to the I/F circuit 411. Then, when the processing in the step S405, the step moves to the step S402.

<Image Control Task>

Next, the image control task will be described with reference to FIG. 12.

<Step S651>

In step S651, the sub-CPU 412 performs initialization processing. To be more specific, the sub-CPU 412 performs the processing for initializing data on an image. Then, when the processing in the step S651 ends, the step moves to step S652.

<Step S652>

In the step S652, the sub-CPU 412 performs processing for performing a sound control task. Here, in this sound control task, the sub-CPU 412 analyzes sound data which is determined in processing for determining sound data in step S405-3 described later (see FIG. 13), and then performs processing for controlling the sound outputted from the speakers 34 and 35, based on the result of the analysis. Then, when the processing in the step S652 ends, the step moves to step S653.

<Step S653>

In the step S653, the sub-CPU 412 performs processing for analyzing image data. To be more specific, the sub-CPU 412 performs the processing for analyzing the image data determined in processing for determining image data in step S405-4 described later. Then, when the processing in the step S653 ends, the step moves to step S654.

<Step S654>

In the step S654, the sub-CPU 412 performs image control processing. To be more specific, the sub-CPU 412 performs the processing for outputting a signal to the image control board 420, based on the result of the analysis by the processing in the step S 653. By this means, the LC display device 41 can display information about the game (for example, the number of games having been played or the number of medals having been acquired in the ART state), or various performance images (for example, images for “super exciting performance”). Then, when the processing in the step S654 ends, the step returns to the step S652.

<Processing for Analyzing a Command>

Next, processing for analyzing a command will be described with reference to FIG. 13. Here, FIG. 13 shows a sub-routine of command analysis processing.

<Step S405-1>

In step S405-1, the sub-CPU 412 performs processing for determining performance contents.

In the processing for determining performance contents, for example, when the game is in the ART state, a lottery is held to add additional games to the number of ART games, based on a lottery table for adding the number of ART games (not shown) provided in the sub-ROM 414. This lottery table for adding the number of ART games stores the increment of the number of ART games and the lottery vale corresponding to the increment. Then, when it is determined to add a predetermined number of games to the number of ART games by the lottery, the sub-CPU 412 performs processing for selecting the performance content (e.g. “super exciting performance” of performance No. 022), based on the performance determination table (see FIG. 6). Here, with the present embodiment, when it is determined to provide “super exciting performance”, the player is prompted to push the performance button 18 according to the LC display device 41, and then pushes the operation button 18, so that the LC display device 41 and the title bar 641 are moved. When the processing in the step S405-1 ends, the step moves to the step S405-2.

<Step S405-2>

In the step S405-2, the sub-CPU 412 performs processing for determining lamp data. To be more specific, the sub-CPU 412 performs the processing for determining the lamp data corresponding to the performance content determined by the processing in the step S405-1. Then, when the processing in the step S405-2 ends, the step moves to the step S405-3.

<Step S405-3>

In the step S405-3, the sub-CPU 412 performs processing for determining sound data. To be more specific, the sub-CPU 412 performs the processing for determining the sound data corresponding to the performance content determined by the processing in the step S405-1. Then, when the processing in the step S405-3 ends, the step moves to step S405-4.

<Step S405-4>

In the step S405-4, the sub-CPU 412 performs processing for determining image data. To be more specific, the sub-CPU 412 performs the processing for determining the image data corresponding to the performance content determined by the processing in the step S405-1. Then, when the processing in the step S405-4 ends, the command analysis processing is terminated, and the step moves to the step S402 in the main board communication task.

As described above, the game machine 1 according to the present embodiment includes the title bar 641 that can be moved from a predetermined default position to a predetermined area; the bar unit 630 that moves the title bar 641; and the LC display device 41. When the title bar 641 is located in the default position, the LC display device 41 covers the title bar 641, and, at the time a predetermined requirement is met, for example, a predetermined number of games is added, the bar unit 630 moves the title bar 641 to an area where the title bar 641 is not covered by the LC display device 41. By this means, the title bar 641 covered by the LC display device 41 suddenly appears, so that the player is astonished and moved because the player did not expect that, so that it is possible to improve the amusement of the player. In addition, with the present embodiment, although one LC display device is provided as “display means” for displaying game information, another configuration is possible where a plurality of LC display devices are provided. Moreover, with the present embodiment, although an LC display device is used as “display device, another display device such as a dot matrix display device is applicable. Furthermore, with the present embodiment, the LC display device 41 that can display information on the game is employed as “second object.” Therefore, the player pays attention to the information on the game displayed on the display device, and consequently might not notice the title bar, so that it is possible to improve the amusement of the player as compared to when the title bar is hidden by an object that displays no information.

In addition, in the game machine 1 according to the present embodiment, when a predetermined requirement is met, the LC drive unit 610 moves the LC display device 41 so that the title bar 641 is no longer covered by the LC display device 41, and the bar unit 630 moves the title bar 641 to be located in front of the LC display device 41. By this means, it is possible to easily check the additional number of games and so forth and to improve the amusement of the player.

Moreover, the game machine 1 according to the present embodiment includes the LC drive unit 610 that moves the LC display device 41. When a predetermined requirement is met, the LC drive unit 610 moves the LC display device 41 to be located in an area where the title bar 641 is no longer covered by the LC display device 41, and the bar unit 630 moves the title bar 641 to be located in front of the LC display device 41. To be more specific, a specific condition is realized, the LC drive unit 610 moves the LC display device 41 upward and the bar unit 630 moves the title bar 641 to be located in front of the LC display device 41, so that the player can see the title bar 641. By this means, it is possible to provide various changes in game performance, and therefore to improve the amusement of the player.

Here, with the present embodiment, the LC drive unit 610 and the bar unit 630 are controlled by the video display processor 421. However, it is by no means limiting, but they may be directly controlled by the LC control CPU 422a or the sub-CPU 412. Moreover, the LC drive unit 610 and the bar unit 630 may be controlled by different controllers, respectively.

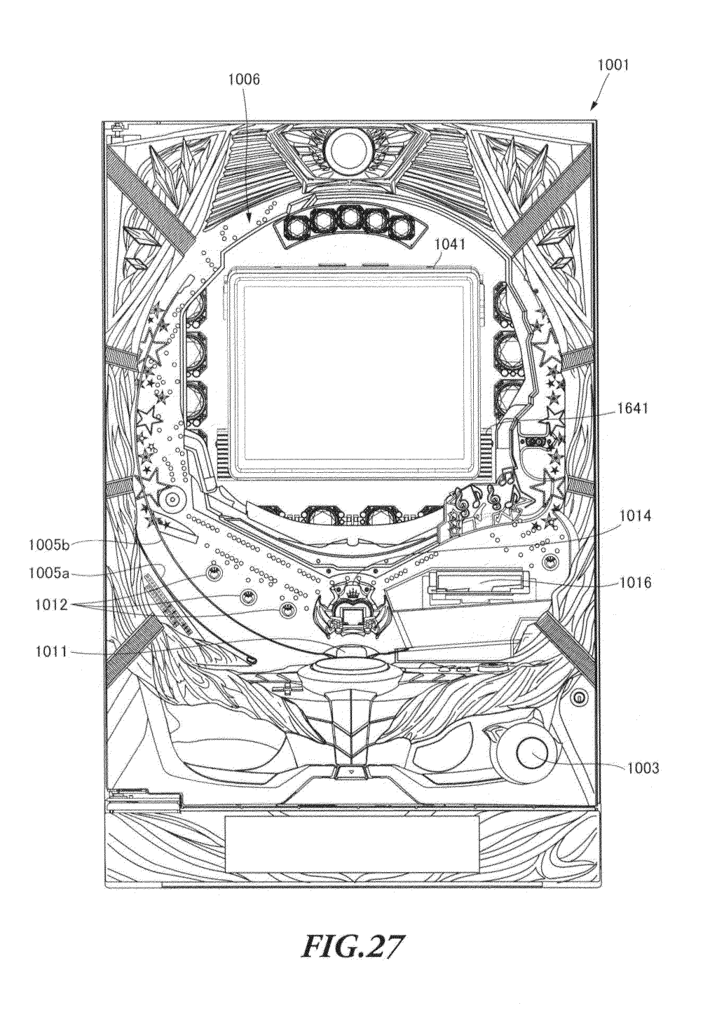

Next, another embodiment will be described where the present invention is applied to a pachinko game machine. FIG. 27 is a front view showing a pachinko game machine 1001.

As shown in FIG. 27, the pachinko game machine 1001 includes an operation handle 1003, rails 1005a and 1005b, a playfield 1006, a main control part and a performance control part (not shown). An outlet 1011, winning holes 1012, a start-up hole 1014, a bonus game gate 1016, an LC display device 1041 and a title bar 1641 are provided in the playfield 1006.

The main control part controls the basic operations of a game. The performance control part controls each performance during the game or for a wait time, and also controls various performance devices, based on a command transmitted from the main control part or signals inputted from an input detection device, a timer and so forth.

By rotating the operation handle 1003, a voltage applied to a launching control board (not shown) can be changed via a launching volume adjusting part formed by a variable resistor that is directly connected to the operation handle 1003. The launching control board rotates a hitting member via a launching solenoid based on the changed voltage, and therefore to hit the playing balls accumulated in the end of the downslope of a launching rail. Therefore, the player rotates the operation handle 1003, so that playing balls are launched.

The rails 1005a and 1005b guide playing balls to the playfield 1006. That is, by rotating the operation handle 1003, the playing balls launched from the launching rail pass between the rail 1005a and 1005b, reach the playfield 1006, and then fall through the playfield 1006. In this case, plurality of pegs and a pinwheel are provided on the playfield 1006, so that the trajectories of the falling playing balls are unpredictable.

The outlet 1011 is provided on the bottom of the playfield 1006 to discharge playing balls which did not enter any of the winning holes 1012, the start-up hole 1014, and the bonus game gate 1016.

The plurality of winning holes 1012 are provided in the playfield 1006, each of which has a winning hole detection switch. When the winning hole detection switch detects a playing ball entering the winning hole, a predetermined prize is provided (for example, ten playing balls are paid out).

The start-up hole 1014 has a start-up hole detection switch that detects a playing ball entering the start-up hole 1014. When the start-up hole detection switch detects a playing ball entering the start-up hole 1014, a lottery is held, which provides the right to play a bonus game (herein after “lottery for bonus game”). Also, when the start-up hole detection switch detects a playing ball entering the start-up hole 1014, a predetermined prize is provided (for example, three playing balls are paid out).

The bonus game gate 1016 is usually closed by a bonus game gate door, so that any playing ball cannot enter the bonus game gate 1016. However, when a bonus game is started, the bonus game gate door opens and serves as a tray to guide a playing ball into the bonus game gate 1016, so that the playing ball can enter the bonus game gate 1016. The bonus game gate 1016 has a bonus game gate detection switch. When the bonus game gate switch detects a playing ball entering the bonus game gate 1016, a predetermined prize is provided (for example, fifteen balls are paid out).

Here, “lottery for bonus game” is processing that is performed when a playing ball enters the start-up hole 1014, in order to acquire a random number value for determining a special symbol and to determine whether the acquired random number value corresponds to “jackpot” or “small win.”

With the present embodiment, “jackpot” means acquisition of the right to play a bonus game in a lottery performed provided that a playing ball enters the start-up hole 1014. In a bonus game, the bonus game gate 1016 opens, for example, fifteen times. The maximum period of time for which the bonus game gate 1016 opens in one round is preset. One round of the game ends if a predetermined number of playing balls has entered in the bonus game gate 1016 during the predetermined period of time. That is, “bonus game” allows the player to acquire a number of playing balls as prizes because playing balls can enter the bonus gate 1016 and the player can acquire the corresponding number of playing balls as prizes.

The LC display device 1041 is provided in an approximately center of the playfield 1006. The LC display device 1041 displays an image during a wait time for the start of a game, and an image corresponding to the progress of the game. For example, the LC display device 1041 displays three performance symbols to inform the result of a lottery for bonus game. Here, in order to inform the player of the acquisition of a bonus game, the LC display device 1041 displays a specific combination of symbols (e.g., 777) while the reels are stopped. In addition, the LC display device 1041 displays performances with animation.

Moreover, the LC display device 1041 includes an LC drive unit. This LC drive unit is a drive mechanism that is controlled by the performance control part to move the LC display device 1041 upward and downward. The configuration and the drive mechanism of the LC drive unit are the same as the above-described LC drive unit 610.

In addition, when the pachinko game machine 1001 is in the initial state, for example, the power supply is turned on, the LC display device 1041 is held in a position where the LC display device 1041 is lowered down. In addition, if a predetermined requirement is met, for example, when a bonus game is acquired, or a predetermined random number value is acquired, the LC drive unit moves the LC display device 1041 upward and downward under the control of the performance control part.

The title bar 1641 is provided in the lower back of the LC display device 1041. The title bar 1641 includes a bar drive unit. This bar drive unit is a drive mechanism that is controlled by the performance control part to move the title bar 1641 forward, backward, upward and downward. The configuration and the drive mechanism of the bar drive unit are the same as the above-described bar unit 630.

In addition, when the pachinko game machine 1001 is in the initial state, for example, the power supply is turned on, the title bar 1641 is held in a lower and back position. Therefore, when the LC display device 1041 and the title bar 1641 are stopped in the initial position, the LC display device 1041 covers the title bar 1641 to be invisible.

In addition, if a predetermined requirement is met, for example, when a bonus game is acquired, or a predetermined random number value is acquired, the bar drive unit moves the title bar 1641 forward, downward, upward and downward under the control of the performance control part.

Here, the operating conditions of the LC display device 1041 by the LC display device may be the same as or different from the operating conditions of the title bar 1641 by the bar drive unit. That is, the LC display device 1041 and the title bar 1641 may be operated together or individually.

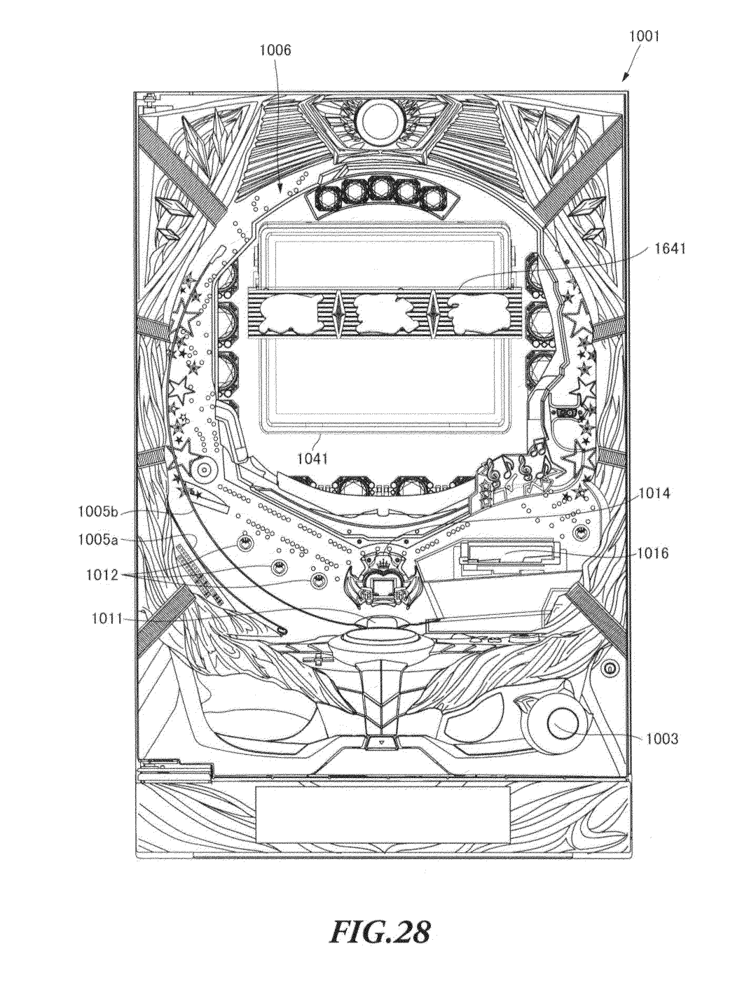

FIG. 28 is a front view showing the pachinko game machine 1001 with the LC display device 1041 and the title bar 1641 in operation. FIG. 28 shows the LC display device 1041 after being moved upward and the title bar 1641 after being moved forward and upward.

By this means, the title bar 1641 hidden by the LC display device 1041 suddenly appears, so that the player is astonished and moved because the player did not expect that, so that it is possible to improve the amusement of the player.

Here, although the embodiment has been described where the present invention is applied to a slot machine and a pachinko game machine, another embodiment is possible where the preset invention is applied to various game machines such as a mahjong ball game machine and an arrange ball game machine.

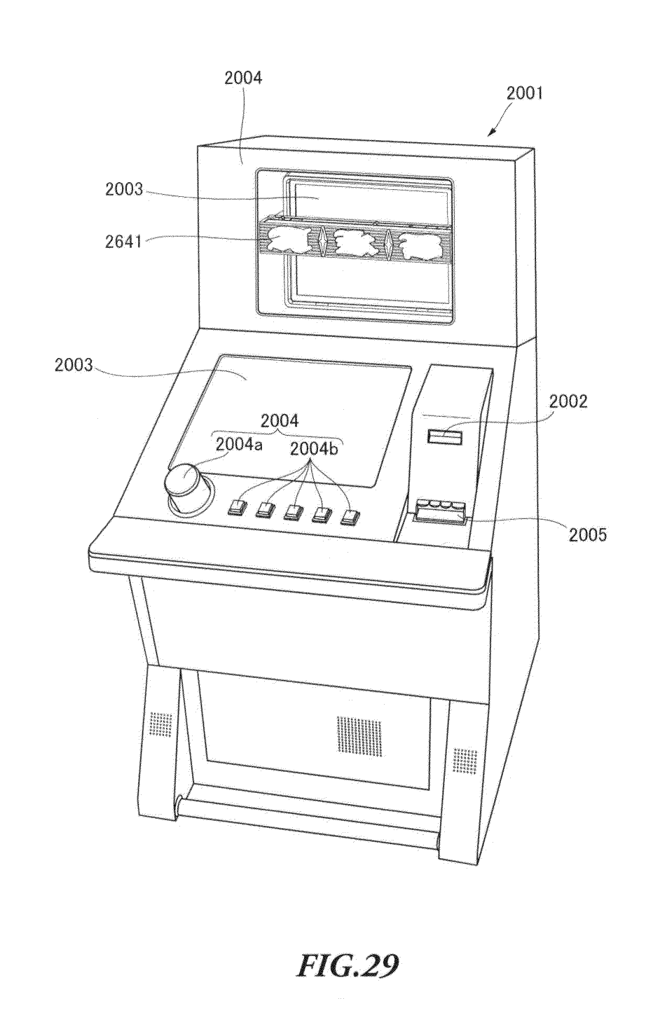

For example, “operation device” as described above may be applicable to video game. Here, a video game device 600 having the operation device according to the present invention will be described with reference to FIG. 29.

As shown in FIG. 29, the video game device 600 can perform a card game (e.g. poker, and baccarat), and a slot machine game. This video game device 2001 includes an insertion slot 2002 into which a card or paper money is inserted; a first image display device 2003 that can display game images of a card game, a slot machine game and so forth; an operation device 2004 that can start and stop the game, and select various images; a payout slot 2005 from which a prize such as a card or paper money can be paid out; a second image display device 2041 that can display a performance image associated with the game; and a title bar 2641.

In the video game device 2001 with the above-described configuration, the operation device 2004 is enabled by inserting a card or paper money into the insertion slot 2002, and can be used to perform a video game such as a card game, a slot machine game and so forth, in the same way as in the above-described game machine 1.

Here, the flow of a video game performed by the video game device 2001 will be described in two cases: when the video game is a card game; and when the video game is a slot machine game.

First, one case in which the video game is a card game (e.g. poker game) will be described. The video game device 2001 is configured to perform a card game by the player. The card game can be performed by inserting a card and so forth into the insertion slot 2002, and then operating the operation button 2004a.

To be more specific, when the operation button 2004a is operated, the first image display device 2003 displays a plurality of rear surface images that imitate the rear surfaces of playing cards, and then, when any of the operation buttons 2004b is operated, the rear surface image corresponding to the operation button 2004b is inverted and a face card image representing a picture is displayed. Then, in a case in which the plurality of face card images constitute a specific condition (e.g. one pair), a prize corresponding to this specific condition is paid out from the payout slot 2005.

Next, the other case in which the game performed by the video game device 2001 is a slot machine game will be described. The video game device 2001 is configured to perform a slot machine game by the player. The slot machine game can be performed by inserting a card and so forth into the insertion slot 2002, and then operating the operation button 803a, in the same way as in the case of a card game.

To be more specific, when the player operates the operation button 2004a, the plurality of still reel images on the first image display device 602 spin at a time, and, when the player operates the operation buttons 2004b, the reel images corresponding to the operation buttons 2004b can be stopped. Then, when the combination of the stopped symbols represents a specific condition, a prize corresponding to the specific condition is paid out from the payout slot 2005.

Next, the LC display device 2041 and the title bar 2641 will be described. The LC display device 2041 is configured to be moved upward and downward by an LC drive unit (not shown) in the same way as the above-described LC display device 41 (see FIG. 23). Here, the configuration and the drive mechanism of the LC drive unit are the same as those of the LC drive unit 610 (see FIG. 15), and therefore overlapping descriptions will be omitted.

In addition, the title bar 2641 is moved forward, backward, upward and downward by a bar unit (not shown) in the same way as the above-described title bar 641 (see FIG. 23). Here, the configuration and the drive mechanism of the bar unit are the same as the above-described LC drive unit 610 (see FIG. 15), and therefore overlapping descriptions will be omitted.

If a predetermined requirement is not met, for example, when a bonus game is not acquired, the title bar 2641 is covered by the LC display device 2041, and therefore cannot or may not be seen from the player.

Here, it will be described that how the LC display device 2041 and the title bar 2641 operate if a predetermined requirement is met, for example, if a specific condition is determined in advance in a card game or slot machine game.

With the present embodiment, when the predetermined requirement is met, first the LC display device 2041 is moved upward. In this state, the title bar 2641 can be seen, which is located below the LC display device 2041.

After that, the title bar 2641 is moved to a position where the player can see the title bar 2641 is placed in front of the LC display device 2041, and then moved upward along the screen of the LC display device 2041.

As described above, with the present embodiment, the video game machine 2001 includes the title bar 2641 that is usually covered by the LC display device 2041 suddenly appears, so that the player is astonished and moved because the player did not expect that, so that it is possible to improve the amusement of the player.

Although the preferred embodiment has been explained, it is by no means limiting, it will be appreciated that various modifications and alterations are possible without departing from the scope of the invention.

1. A game machine comprising:
a performance device configured to be able to provide various performances corresponding to a progress of a game,
the performance device including:
a first object configured to be able to move;
a mover configured to move the first object; and
a second object configured to be able to hide the first object from a player, wherein:
the first object can move between a first position where the first object is covered by the second object that is located in a predetermined position and a second position where the first object is not covered by the second object; and
when a predetermined requirement is met, the mover moves the first object from the first position to the second position.

2. The game machine according to claim 1, further comprising a display device configured to display information on a game, wherein in the second position, the display device overlaps the first object in a direction of eyes of the player looking at the first object.

3. The game device according to claim 2, wherein the mover reciprocates the first object within a predetermined range, the first object being located in front of the display device displaying the information on the game when viewed from the player.

4. The game machine according to claim 1, wherein the second object includes the display device configured to display information on the game.

5. The game machine according to claim 4, further comprising a second mover configured to move the second object, wherein:
the second object can move between the predetermined position and a second predetermined position where the second object does not hide the first object located in the first position from the player; and
when the predetermined requirement is met, the second mover moves the second object from the predetermined position to the second predetermined position.

6. The game machine according to claim 5, wherein the mover moves the first object from the first position to the second position after the second mover starts to move the second object.
